(19) United States
(12) Patent Application Publication
(10) Pub. No.: US 2017/0087468 A1
(43) Pub. Date: Mar. 30, 2017

(54) MOBILE APPLICATION FOR REAL-TIME, CUSTOMIZABLE SCOREBOARDING

(71) Applicant: Sivaraman Chinnaswamy Jayaraman, Santa Clara, CA (US)

(72) Inventor: Sivaraman Chinnaswamy Jayaraman, Santa Clara, CA (US)

(21) Appl. No.: 14/870,832

(22) Filed: Sep. 30, 2015

(51) Int. Cl. A63F 13/65; H04L 29/06; H04L 29/08; A63B 71/06

(52) U.S. Cl. CPC A63F 13/65; A63B 71/06; H04L 65/40; H04L 67/10

(57) ABSTRACT

The application is designed to support scoring of non time-based, time-based and race-based games, whether conventional or nonconventional. Examples of non time-based games include tennis, volleyball, badminton, sepak takraw, throw ball, table football, gilli danda and pittu garam. Examples of time-based games include soccer, hockey, ice hockey, kho-kho and kabadi. Race-based games, which involves ranking teams or participants, would include activities such as running, swimming, rowing, singing and dancing.

### CROSS-REFERENCE TO RELATED APPLICATIONS

None.

### FEDERALLY-SPONSORED RESEARCH

Not applicable.

### SEQUENCE LISTING

Not applicable.

### BACKGROUND

It is increasingly commonplace for software development companies to develop multiplayer mobile applications that allow players to play other individuals and groups in real-time on their tablets and smartphones. This technology has been expanded to the sports arena whereby players can participate in defined leagues, such as fantasy football. Additionally, scoreboard functionality is ubiquitously integrated into online and mobile games for updating, recording and comparing player, team and league scores and statistics. With this existing functionality, however, gaming technology lacks a mobile application where users can seamlessly create a scoreboard for any type of game—whether existing or novel—and any number of players or teams, and manage game scoring and administration in real time, while also enabling streaming and sharing of the real-life gaming event with other interested users.

### SUMMARY OF THE INVENTION

The application is designed to support scoring of non time-based, time-based and race-based games, polling based games whether conventional or nonconventional. Examples of non time-based games include tennis, volleyball, badminton, sepak takraw, throw ball, table football, gilli danda and pittu garam. Examples of time-based games include soccer, hockey, ice hockey, kho-kho and kabadi. Race-based games, which involves ranking teams or participants, would include activities such as running, swimming, rowing, singing and dancing.

One who uses the application is called a “user” and a user must connect a valid personal email account to his user account. A user can customize his account with personal information such as associations with schools, colleges and businesses. A user who wishes to participate in a game must create at least one Player ID, which will be associated with his user account by default. A user can create one or more player id.

A user who creates a Team is called a Team Administrator, and the Team Administrator can take actions such as creating and deleting other Team Administrators and adding Players to the Team and removing Players from the team. A team can have one or more Players and a Player can belong to zero, one or more Teams. A user who creates a League is called a League Administrator, and the League Administrator can take actions such as creating and deleting other League Administrators and adding Players or Teams to the League. Leagues are generally created a specific game type and can have one or more associated Teams or Players.

A “Match” is the base unit of play in the application. A Match may be played by Players or Teams of Players. Matches can be played among individual Players or Teams or by members of a League. The Player who creates a Match is the Match Administrator by default and can take action such as setting the Match criteria, selecting one or more Scorers (or referees) for the Match, and selecting the Players or Teams to participate in the Match. The Scorer has the ability to update Match scores, as well as credit points to Players on participating Teams where such Players played pivotal roles in the Team's scoring.

A user can follow the activities of a specific Player, Team, League or Match, as well as a general game type such as hockey or volleyball or the activities of those associated with an organization such as a school or company. Whenever a score or player credit is updated for a Match, a notification will appear on the home screen of a user who elected to follow that Match or a Player, Team, League, game type or organization associated with that Match.

An Administrator or Scorer has the same capabilities as a general user, but a user who is not an Administrator or Scorer can only view match information (e.g., names of participants and scores or player credits) and upload Media (images or audio or video files) documenting a particular Match, add comments to the match, which will alert and be viewable to all other users following that Match.

The embodiments described herein are illustrative of the invention, and it is to be understood that the invention is not limited in its application to the details of construction and to the arrangements of the components set forth in the following description and drawings. The invention is capable of other embodiments and of being practiced and carried out in various ways. It should be further understood that the phraseology and terminology applied herein merely serve the purpose of description and should not be regarded as limiting.

### BRIEF DESCRIPTION OF THE DRAWINGS

FIG. 1 is a flowchart showing one embodiment of the overall scoreboarding application scheme.

FIG. 2 is a flowchart showing one embodiment of the process by which a user of the application creates a user account.

FIG. 3 is a flowchart showing one embodiment of the process by which a user of the application creates a new Player ID.

FIG. 4 is a flowchart showing one embodiment of the process by which a user of the application transfers a Player ID to another user.

FIG. 5 is a flowchart showing one embodiment of the process by which a user of the application deletes an existing Player ID.

FIG. 6 is a flowchart showing one embodiment of the process by which a user of the application creates a new Team ID.

FIG. 7 is a flowchart showing one embodiment of the process by which a user of the application adds a Player ID to an existing Team.

FIG. 8 is a flowchart showing one embodiment of the process by which a user of the application creates a new User Admin ID.

FIG. 9 is a flowchart showing one embodiment of the process by which a user of the application removes a Player ID as Admin.

FIG. 10 is a flowchart showing one embodiment of the process by which a user of the application creates a new League ID.

FIG. 11 is a flowchart showing one embodiment of the process by which a user of the application adds a League Admin to a League.

FIG. 12 is a flowchart showing one embodiment of the process by which a user of the application adds a Team or Player ID to a League.

FIG. 13 is a flowchart showing one embodiment of the process by which a user of the application removes a Player or a Team from a League.

FIG. 14 is a flowchart showing one embodiment of the process by which a user of the application creates a new Individual Player Match and adds Players to the new Match.

FIG. 15 is a flowchart showing one embodiment of the process by which a user of the application creates a new Team Match and adds teams to the new Match.

FIG. 16 is a flowchart showing one embodiment of the process by which a user of the application selects a Team ID, Player ID, user email address or League ID to follow.

FIGS. 17A-E depict of one embodiment of a Time-Based Team Match creation screen, referee scoreboard, read-only match scoreboard, player credit adjustment screen and read-only player credit screen, respectively.

FIGS. 18A-C depict of one embodiment of a Non Time-Based Team Match creation screen, referee scoreboard and match scoreboard, respectively.

FIGS. 19A-E depict of one embodiment of a Time-Based Individual Match creation screen, referee 1 scoreboard, referee 2 scoreboard, referee 3 scoreboard and match scoreboard, respectively.

FIGS. 20A-C depict of one embodiment of a Non Time-Based Individual Match creation screen, referee scoreboard and match scoreboard, respectively.

FIGS. 21A-G depict of one embodiment of a Race-Based Individual Match creation screen, referee scoreboard after lap 1, match scoreboard after lap 1, referee scoreboard after lap 2, match scoreboard after lap 2, referee scoreboard after lap 3, and match scoreboard after lap 3, respectively.

FIG. 22 is a table showing the scores that would appear on the app scoreboard for a match having two players and two referees for each of the four score types.

FIG. 23 is a table showing the round winner and match winner for a match having two players and three rounds.

FIGS. 24A-D depict one embodiment of the read-only screen for a user poll, poll creation screen, poll creation confirmation screen, and poll entry screen, respectively.

FIGS. 25A-C depict one embodiment of a user's Homescreen, Player/Team/League/Match ID management screen, and Team and League player management screen, respectively.

FIG. 26 is a simplified schematic diagram of a system for customizable scoreboarding.

### DETAILED DESCRIPTION

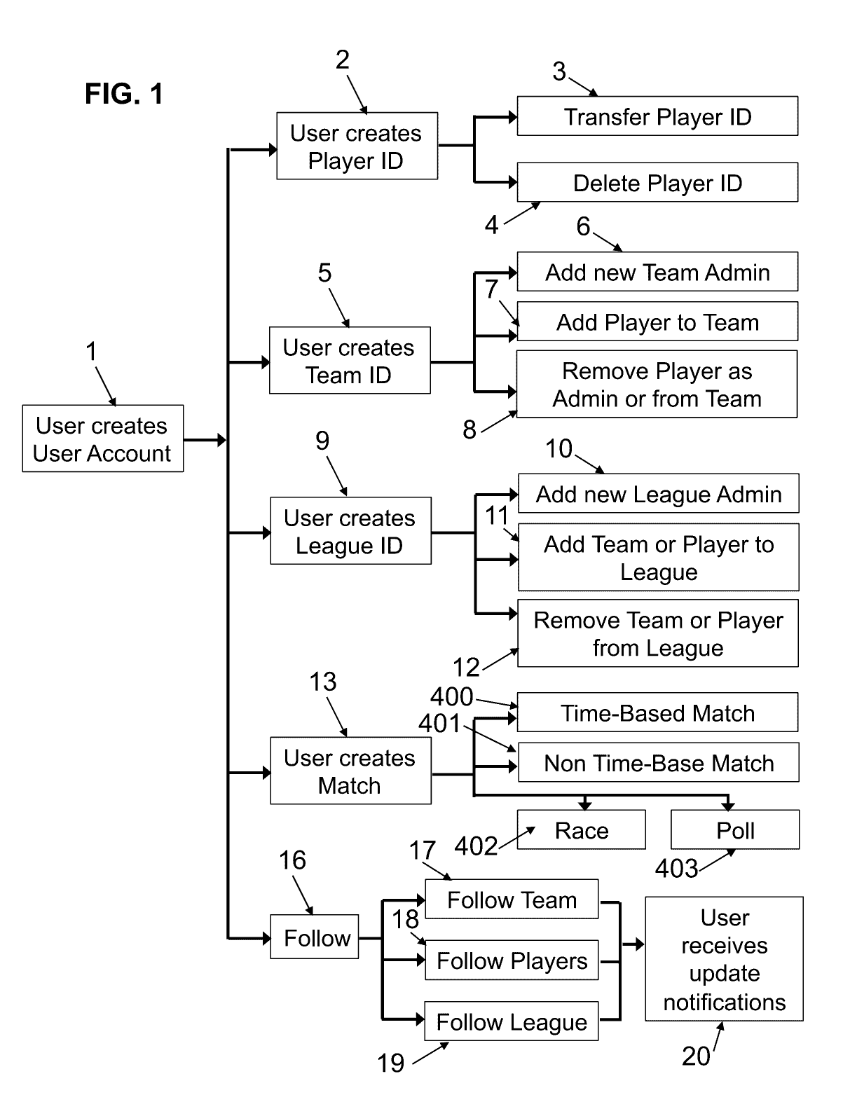

FIG. 1 is a flowchart showing one embodiment of the overall scoreboarding application scheme. To use the application, a user first creates a User Account 1. Having a User Account, a user is able to create a Player ID 2, create a Team ID 5, create a League ID 9, create a Match 13 or Follow 16 an activity on the application. After a user creates a Player ID 2, the user can then transfer that Player ID to another user 3 or delete that Player ID 4. After a user creates a Team ID 5, the user can then add a new Team Admin 6, add a Player to a Team 7 or remove a player as Admin or from a Team 8. After a user creates a League ID 9, the user can then add a new League Admin 10, add a Team or Player to a League 11 or remove a Team or Player from a League 12. Once a user creates a Match 13, the user can set it as a time-based match 400, a non time-based match 401, a race 402 or a poll 403. When a user wishes to Follow 16 an activity, the user can elect to follow a Team 17, a Player 18 or a League 19, and the user will then receive update notifications 20, based on the activity of that election.

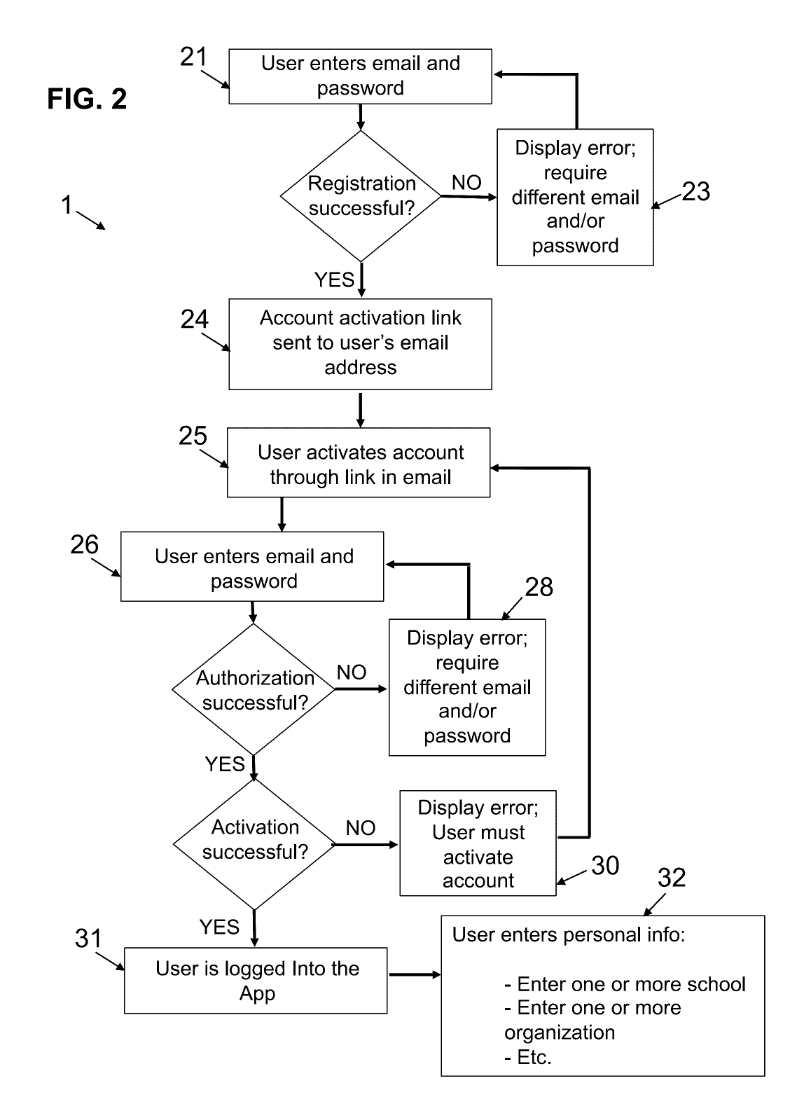

FIG. 2 is a flowchart showing one embodiment of the process by which a user of the application creates a user account. The user creates an account 1 by entering their email and a desired password 21. If registration of the entered email and password is not successful, an error message will be displayed and the user will be required to enter a different email address and/or password 23. If registration is successful, an account activation link will be provided to the user, such as through the user's given email address 24. The user then activates 25 their account through the given link and enters their email address and password 26 to gain access to their new account. If the provided information is not correct and the account is not authorized, an error will display and the user will be required to repeat the authorization process 28. If authorization is successful but account activation is not successful, an error will display and the user will be required to try activating their account again 30. If both authorization and activation are successful, the user is then logged into the application 31, and from there the user can enter their desired account details, such as a school or organizational affiliate 32.

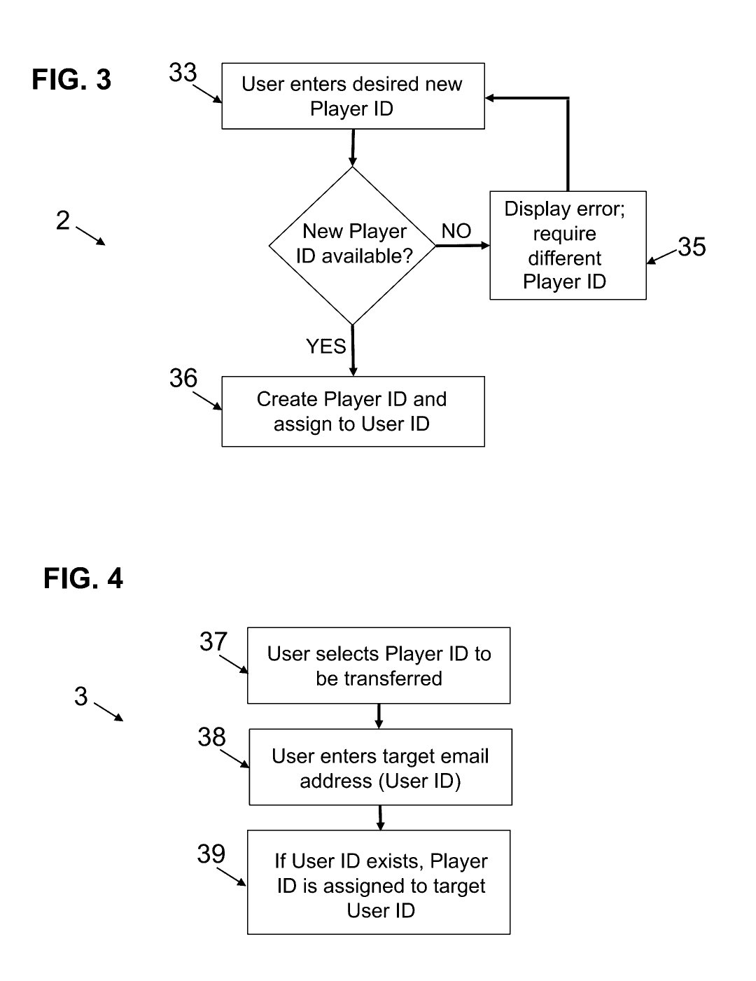

FIG. 3 is a flowchart showing one embodiment of the process by which a user of the application creates a new Player ID 2. To create a new Player ID, a user first enters the desired ID 33. If the entered ID already exists, an error displays and the user is required to select a different Player ID 35. If the desired Player ID does not already exist, the Player ID is created and assigned to the user through association with the user's email address (“User Id”) 36.

FIG. 4 is a flowchart showing one embodiment of the process by which a user of the application transfers a Player ID to another user 3. The user selects a Player ID associated with that user's User ID to be transferred to another user 37. After selecting the Player ID, the user enters the User ID of the person to whom the user wishes to transfer the Player ID 38, and the Player ID is then assigned to the specified User ID 39.

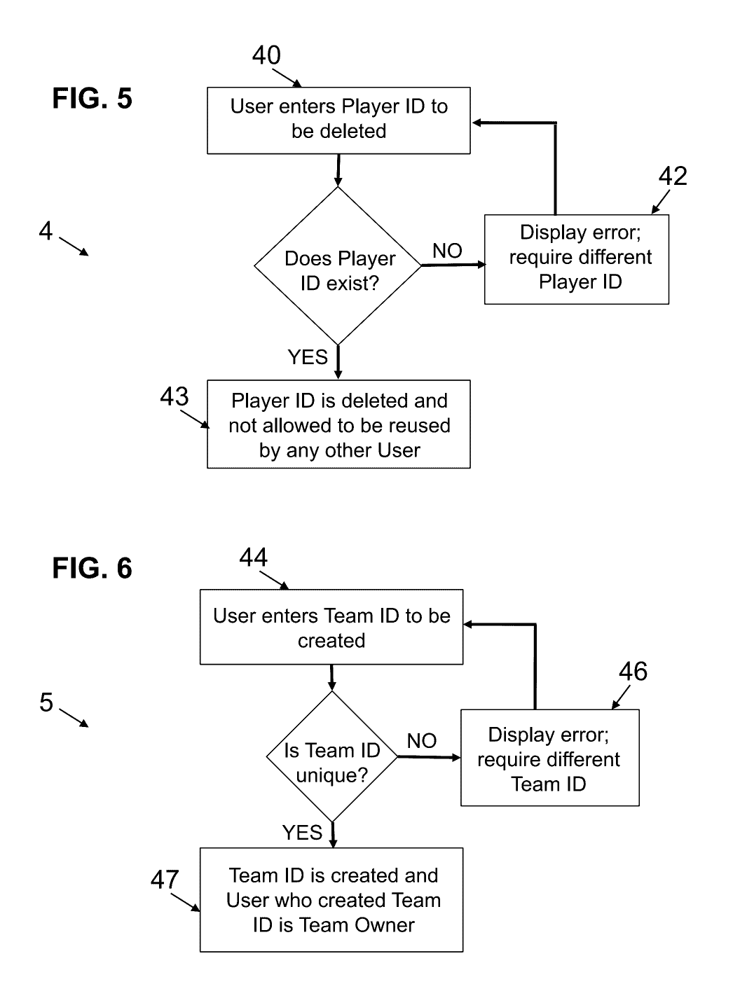

FIG. 5 is a flowchart showing one embodiment of the process by which a user of the application deletes an existing Player ID 4. The user enters a Player ID to be deleted 40. If the entered ID does not exist, an error is displayed and the user is required to enter an existing Player ID 42. If the ID does exist, the Player ID is deleted cannot be reused by any other user 43.

FIG. 6 is a flowchart showing one embodiment of the process by which a user of the application creates a new Team ID 5. The user enters Team ID to be created 44. If the entered Team ID does not exist, an error is displayed and the user is required to enter a unique Team ID 46. If the ID does not already exist, the Team ID is created and the user who created the Team is the Team Owner (or Administration) 47.

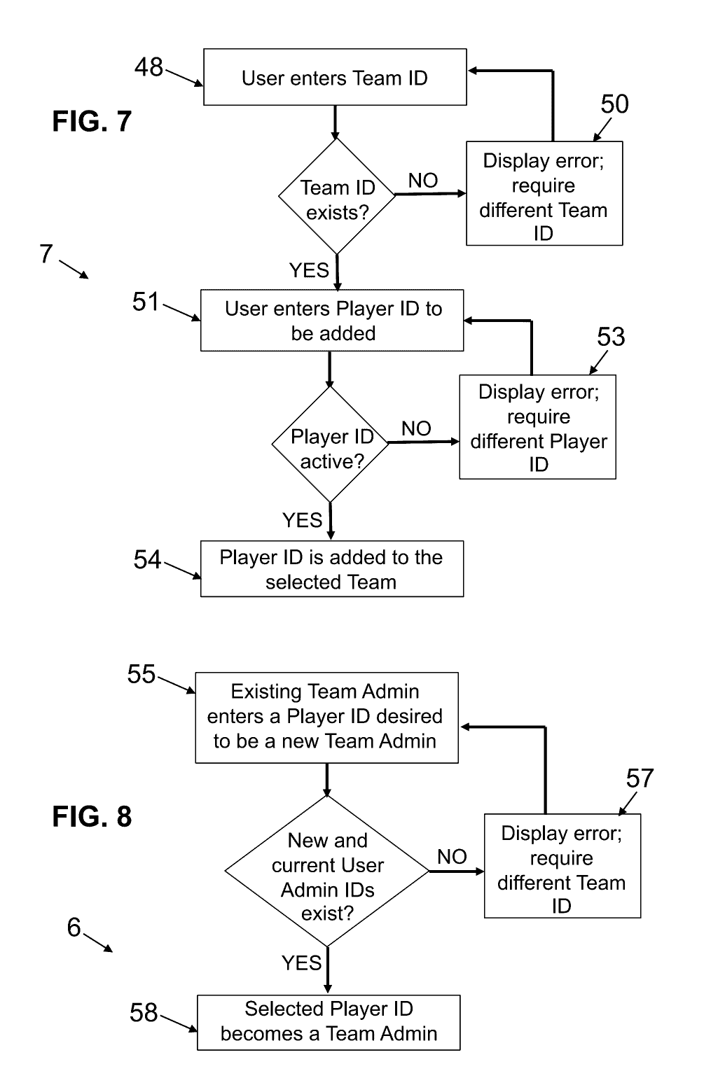

FIG. 7 is a flowchart showing one embodiment of the process by which a user of the application adds a Player ID to an existing Team 7. The user enters a Team ID 48. If the Team ID does not already exist, an error displays and the user is required to enter a different Team ID 50. If the Team ID exists, the user then enters the Player ID to be added to the Team 51. If the entered Player ID is not already active, an error displays and the user is required to enter a different Player ID 53. If the Player ID is active, the entered Player ID is added to the selected Team 54.

FIG. 8 is a flowchart showing one embodiment of the process by which a user of the application creates a new User Admin ID 6. An existing Team Admin enters a Player ID the existing Admin desires to be a new Team Admin 55. If either the user is not an existing Team Admin or the entered Player ID does not exist, an error displays and the user must enter a different Player ID 57. If the user is a Team Admin and the entered Player ID exists, the selected Player ID becomes a Team Admin 58.

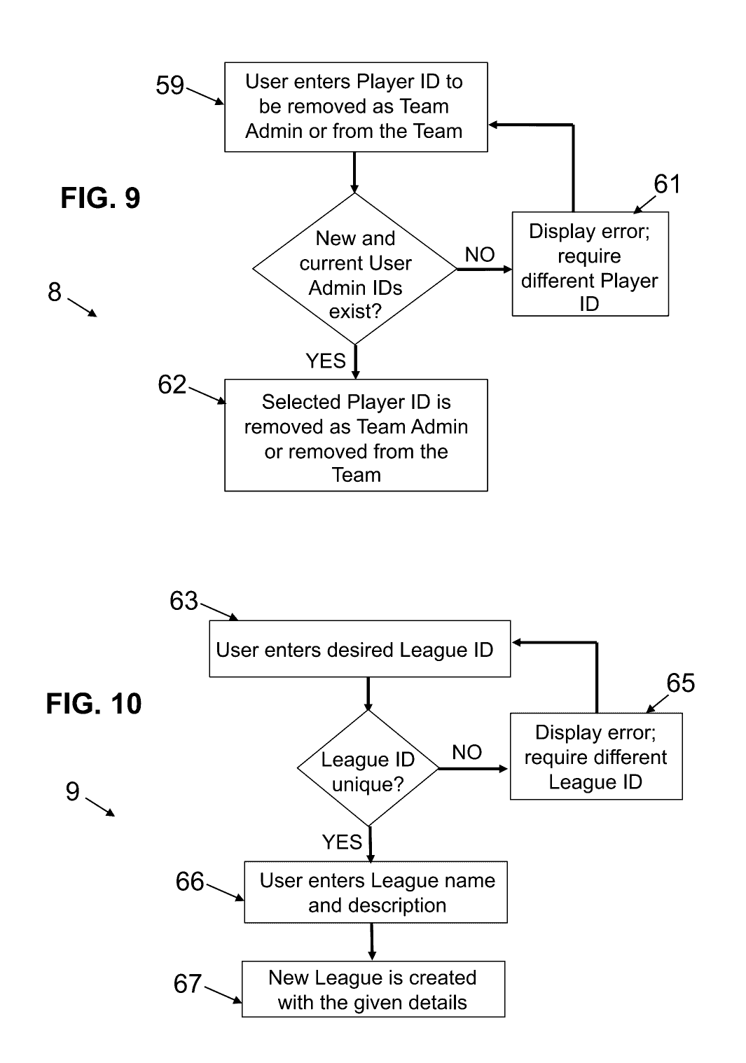

FIG. 9 is a flowchart showing one embodiment of the process by which a user of the application removes a Player ID as Admin 8. User enters Player ID to be removed as Team Admin or from the Team 59. If the new and current User Admin IDs do not exist, an error is displayed and the user is required to enter a different Player ID 61. If the new and current User Admin IDs exist, the selected Player ID is removed as Team Admin or removed from the Team, as specified by the user 62.

FIG. 10 is a flowchart showing one embodiment of the process by which a user of the application creates a new League ID 9. User enters desired League ID 63. If the selected League ID already exists, an error is displayed and the user is required to enter a different League ID 65. If the selected League ID does not already exist, the user is prompted to enter a League name and description 66, and the new League is then created 67.

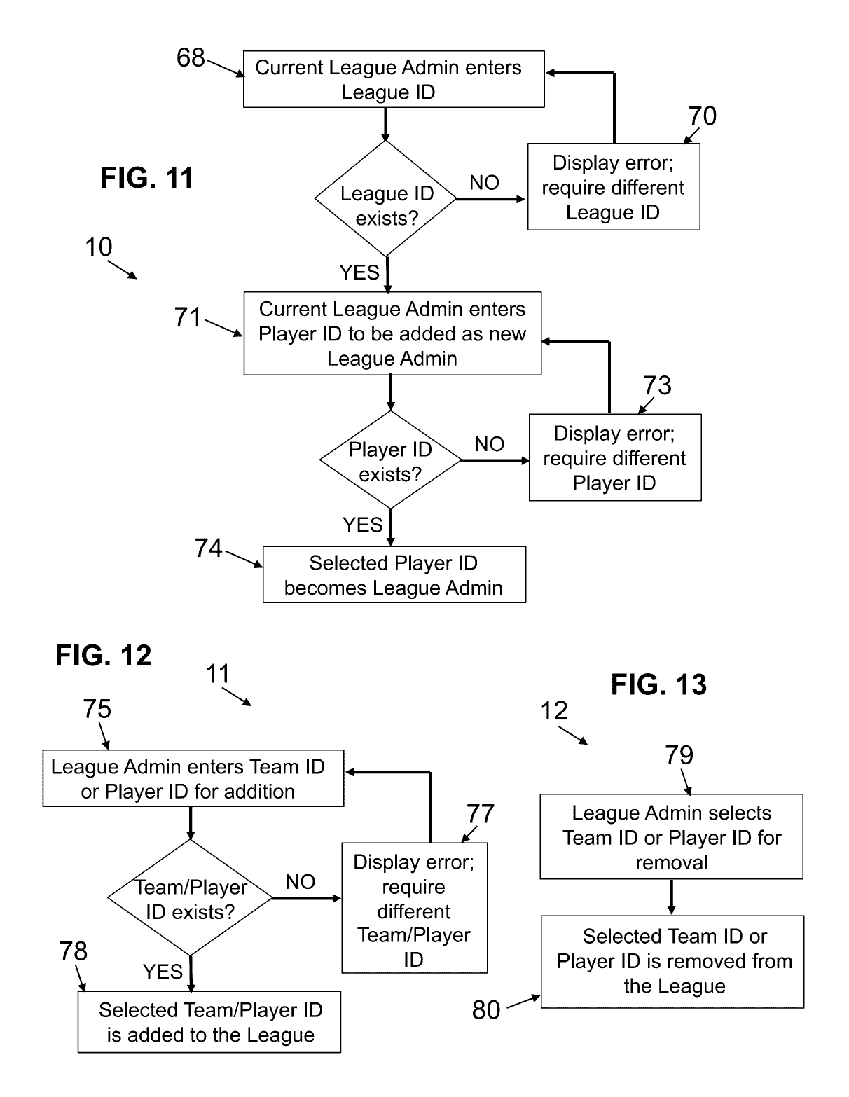

FIG. 11 is a flowchart showing one embodiment of the process by which a user of the application adds a League Admin to a League 10. Current League Admin enters League ID 68. If the selected League ID does not exist, an error displays and the user is required to enter an existing League ID 70. If the selected League ID does exist, the current League Admin enters a Player ID to be added as new League Admin 71. If the selected Player ID does not exist, an error is displayed and the user is required to enter a different Player ID 73. If the Player ID exists, the selected Player ID becomes League Admin 74.

FIG. 12 is a flowchart showing one embodiment of the process by which a user of the application adds a Team or Player ID to a League 11. A League Admin enters a Team ID or Player ID 75. If the selected Team or Player ID does not exists, an error is displayed and the user is required to enter a different Team or Player ID 77. If the selected Team or Player ID exists, that Team or Player ID is added to the League 78.

FIG. 13 is a flowchart showing one embodiment of the process by which a user of the application removes a Player or a Team from a League 12. League Admin selects Team ID or Player ID for removal 79, and the selected Team ID or Player ID is removed from the League 80.

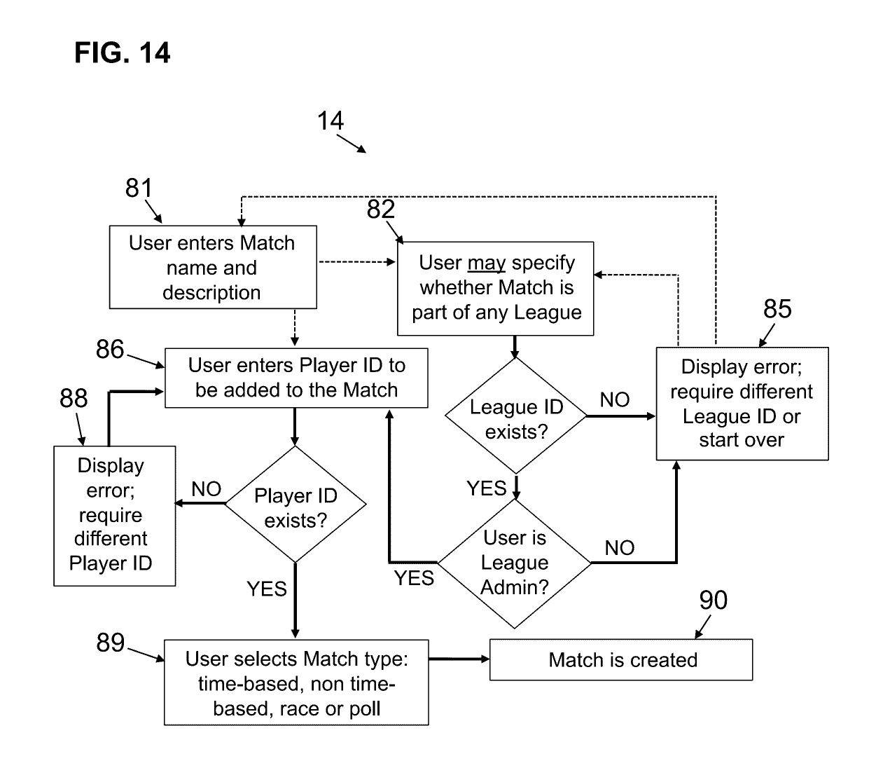

FIG. 14 is a flowchart showing one embodiment of the process by which a user of the application creates a new Individual Player Match and adds Players to the new Match 14. User enters Match name and description 81. At that point, the user may specify whether the Match is part of a League by entering a League ID 82. If the entered League ID does not exist, an error displays and the user must enter a different League ID 85. If the entered League ID exists but the user is not an a League Admin for the specified League, an error displays and the user must enter a different League ID 85. If the specified League ID exists and the user a League Admin, the Match is added to the League and the user then selects a Player ID to be added to the new Match 86. If the user does not wish to make the new Match part of a League, the user simply enters the Match name and description 81 and then enters a Player ID to be added to the new Match 86. If the entered Player ID exists, the user then selects the Match type—time-based, non time-based, race or poll—to be created 89 and then the Match is created 90. If the entered Player ID does not exist, an error displays and the user must enter a different Player ID 88.

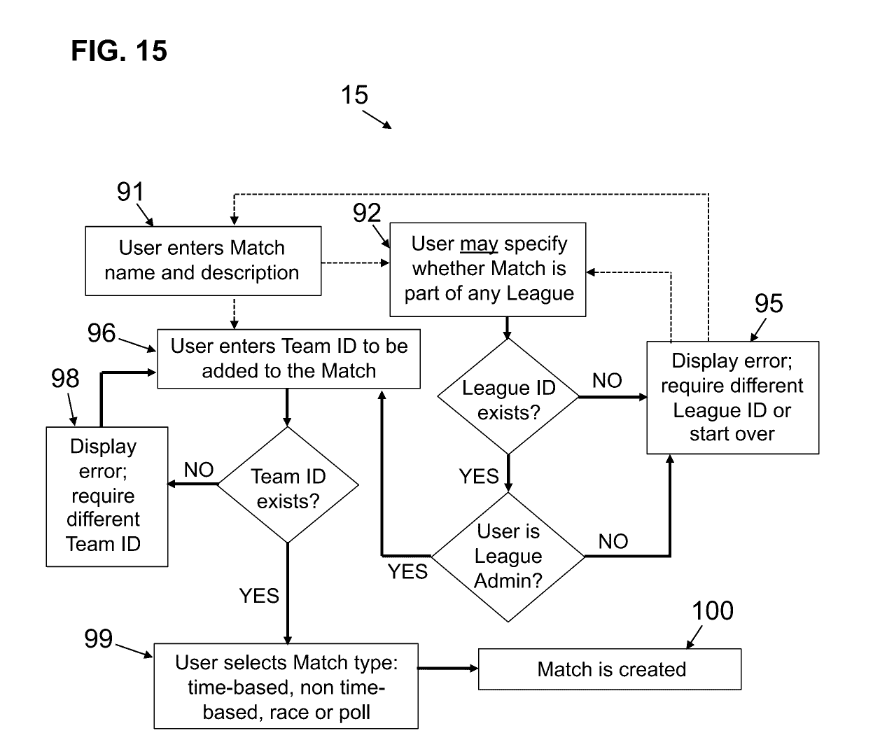

FIG. 15 is a flowchart showing one embodiment of the process by which a user of the application creates a new Team Match and adds Players to the new Match 15. User enters Match name and description 91. At that point, the user may specify whether the Match is part of a League by entering a League ID 92. If the entered League ID does not exist, an error displays and the user must enter a different League ID 95. If the entered League ID exists but the user is not a League Admin for the specified League, an error displays and the user must enter a different League ID 95. If the specified League ID exists and the user a League Admin, the Match is added to the League and the user then selects a Team ID to be added to the new Match 96. If the user does not wish to make the new Match part of a League, the user simply enters the Match name and description 91 and then enters a Team ID to be added to the new Match 96. If the entered Team ID exists, the user then selects the Match type—time-based, non time-based, race or poll—to be created 99 and then the Match is created 100. If the entered Player ID does not exist, an error displays and the user must enter a different Player ID 98.

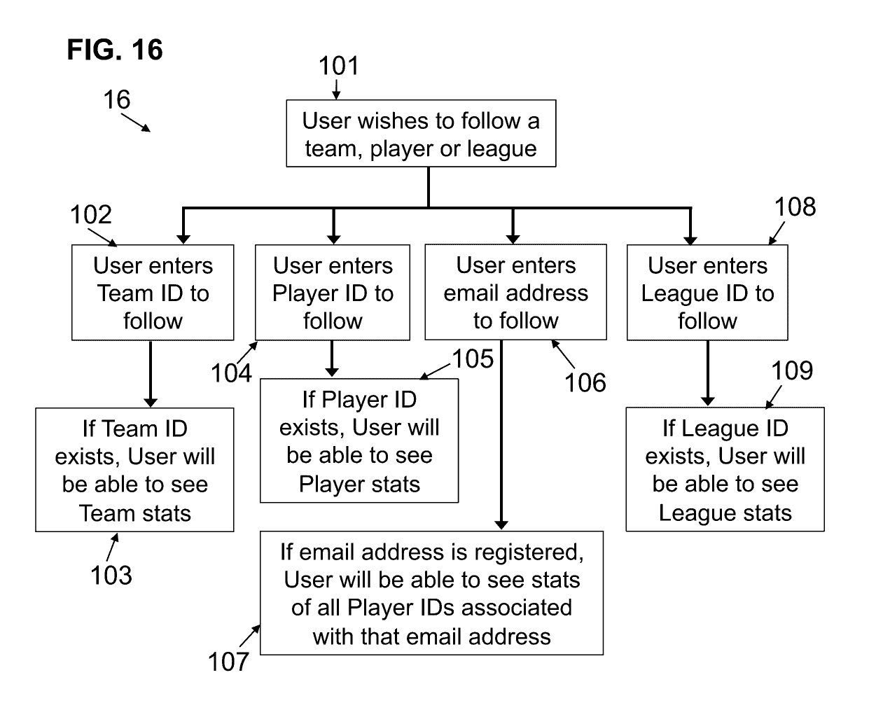

FIG. 16 is a flowchart showing one embodiment of the process by which a user of the application selects a Team ID, Player ID, user email address or League ID to follow 16. If a user wishes to follow a team, player or league 101, the user can enter a Team ID 102, Player ID 104, user email address 106, or League ID 108 to follow activity associated with that selection. After a user enters an existing Team ID to follow 102, the user will be able to view that Team's statistics 103. After a user enters an existing Player ID to follow 104, the user will be able to see that Player's statistics 105. After a user enters a valid email address to follow 106, the user will be able to see statistics of all Player IDs associated with that email address 107. When a user enters a valid League ID to follow 108, the user will be able to see that League's statistics 109.

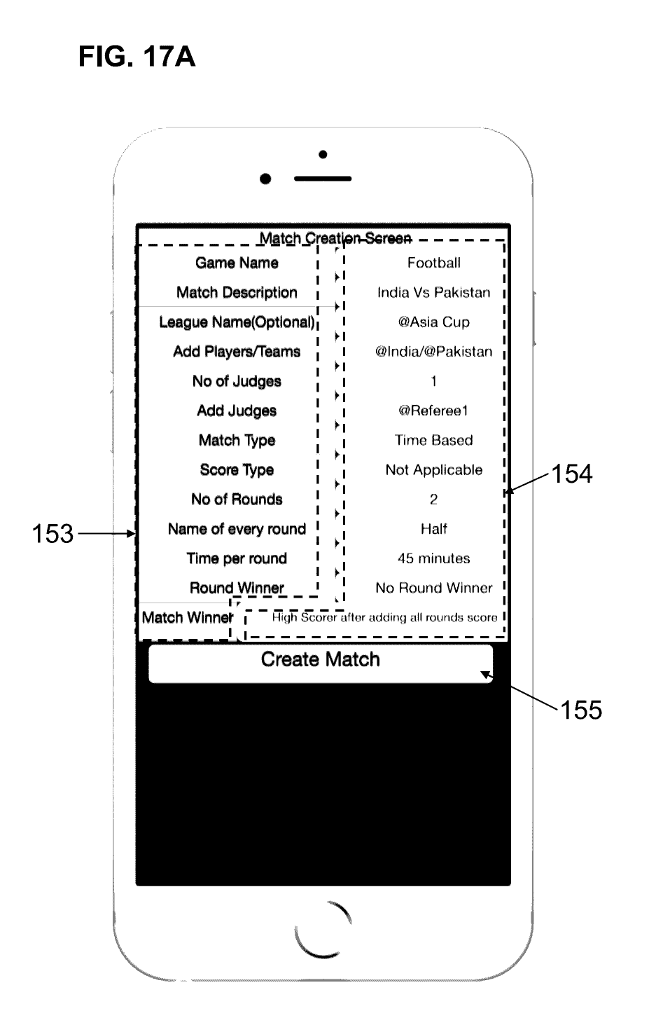

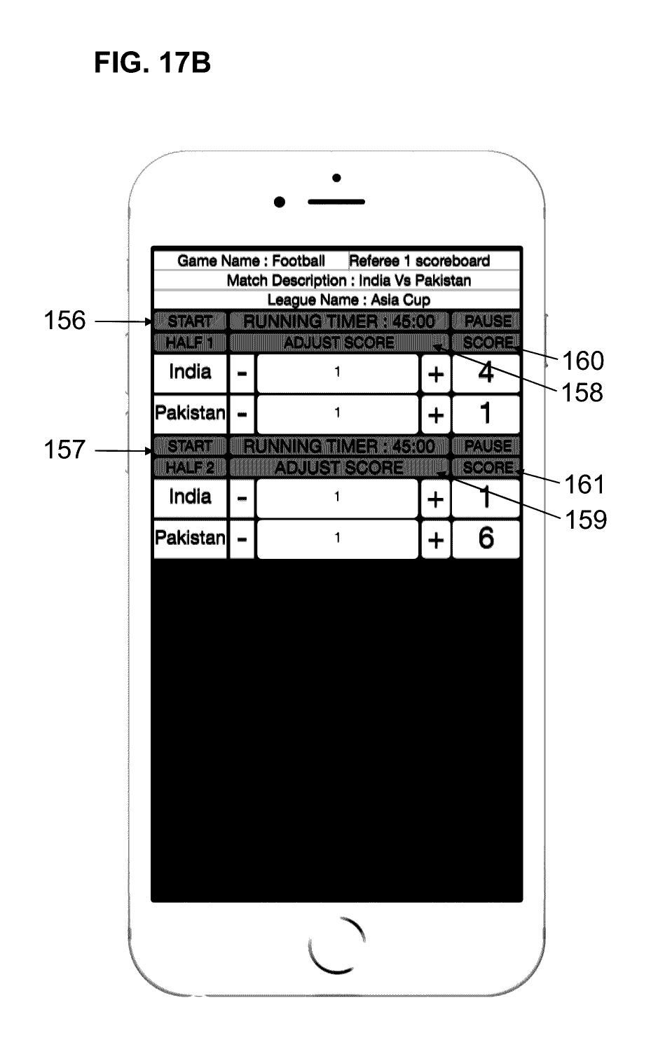

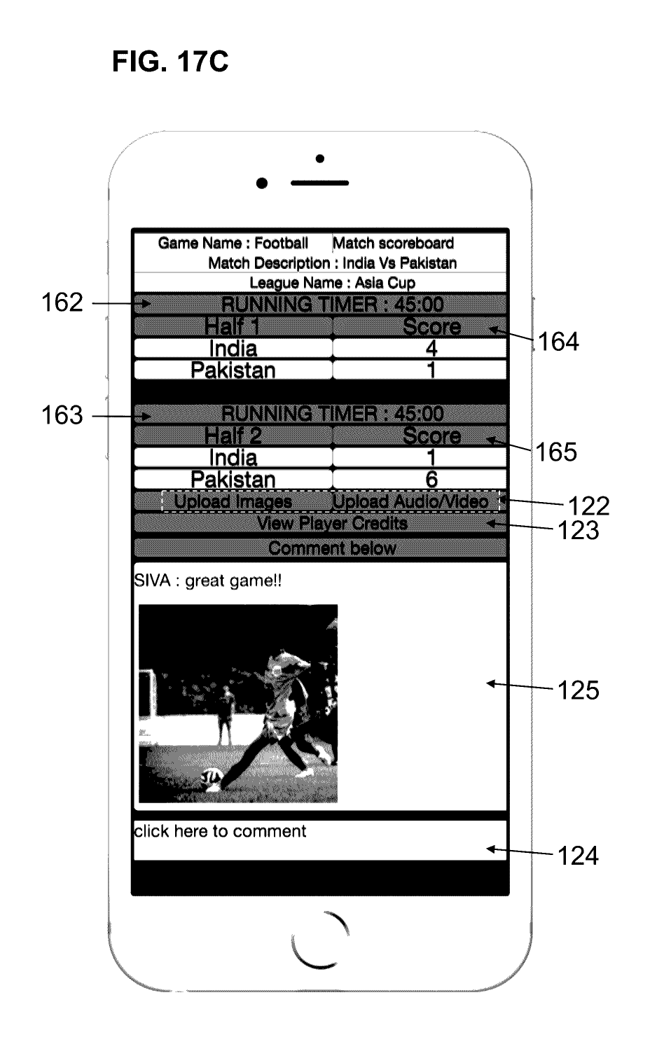

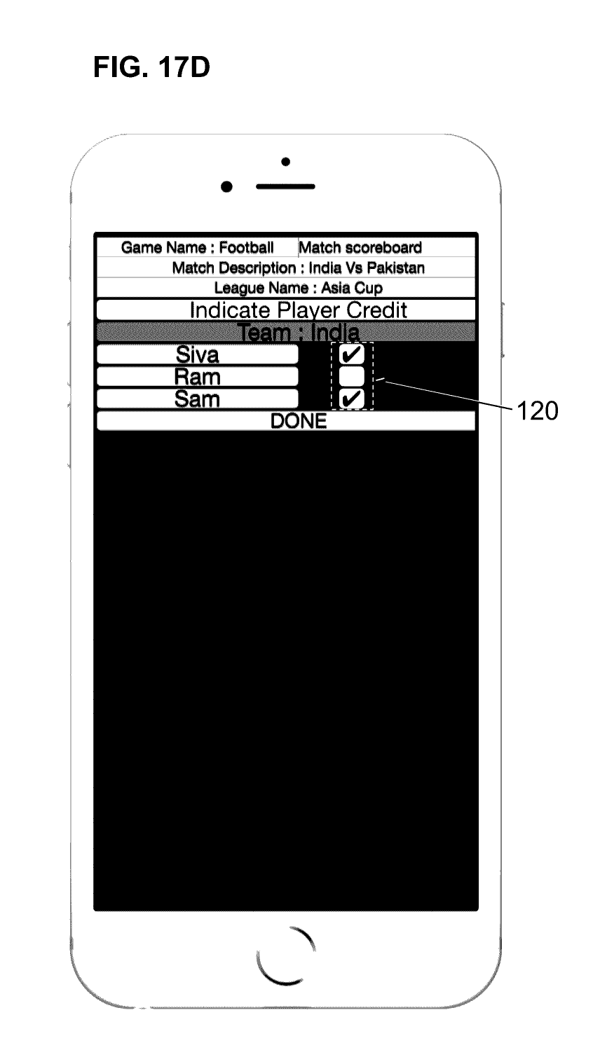

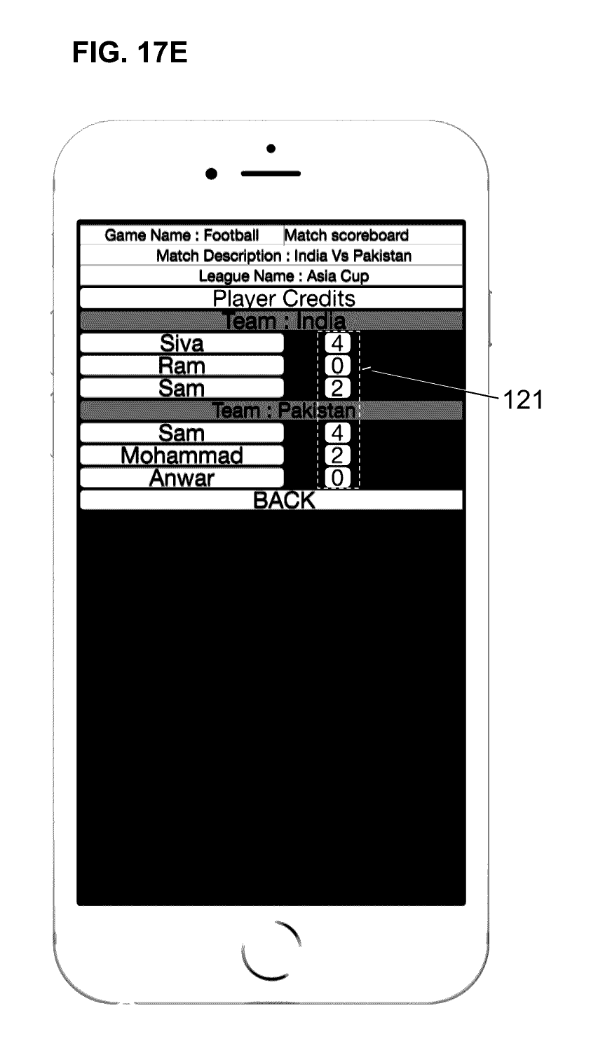

FIGS. 17A-E depict of one embodiment of a Time-Based Team Match creation screen, referee scoreboard, read-only match scoreboard, player credit adjustment screen, and read-only player credit screen, respectively. FIG. 17A shows one embodiment of a list of Match Creation criteria 153, the corresponding information as would be entered by a user creating a Match for a football game 154, like number of referees (judges), score type, round winner, match winner, name of the round and a button that would be selected when the user has entered the Match information and is ready to created the Match 155. FIG. 17B shows one embodiment of the referee scoreboard for the Match created in FIG. 17A having running timers for the first half 156 and second half 157, score adjustment options for each team for the first half 158 and second half 159, and current scores for each team for the first half 160 and second half 161. FIG. 17C shows one embodiment of the Match scoreboard having running timers for the first half 162 and second half 163 and final scores for each team for the first half 164 and second half 165. A user has the option to click on a button to view Player Credits 123, A user also has the option to upload an image or audio or video file 122 or to add a comment 124, which will be posted for all users following the Match to see. Follows of the Match will also be alerted to any upload or comment via a notification on their Home Screen. The user can view all uploads and comments for the Match on this screen 125. FIG. 17D shows one embodiment of the player credit adjustment screen where a referee can check a box 120 next to the name(s) of the player(s) who are given credit for their individual performances. This screen would be shown whenever match score is updated. FIG. 17E shows one embodiment of the read-only player credit screen where a user can view the credits given to individual players on teams playing in a match 121.

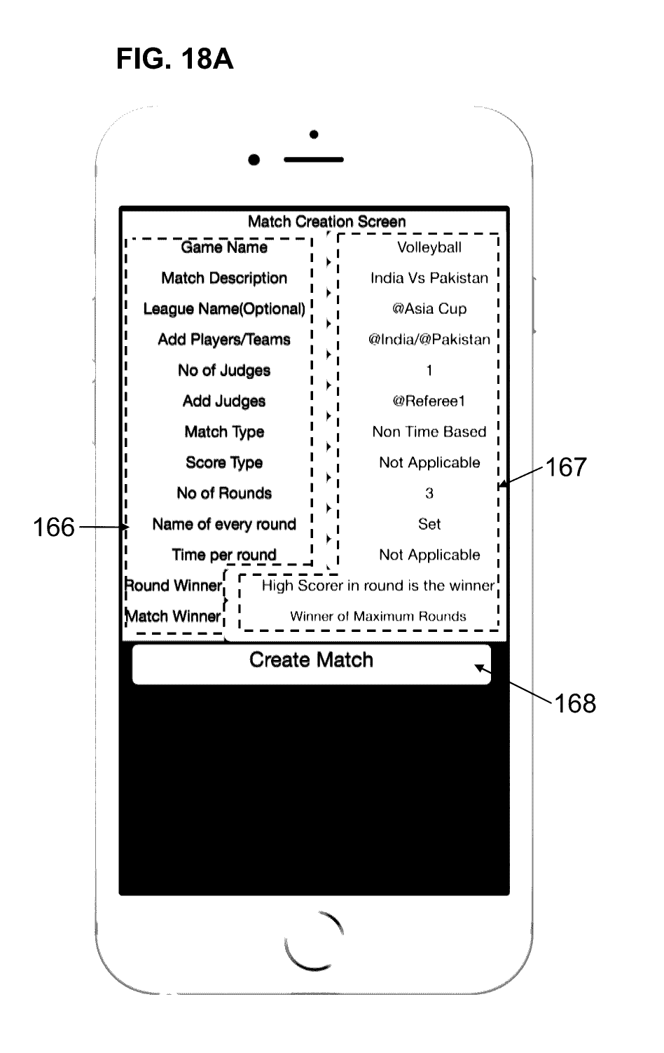

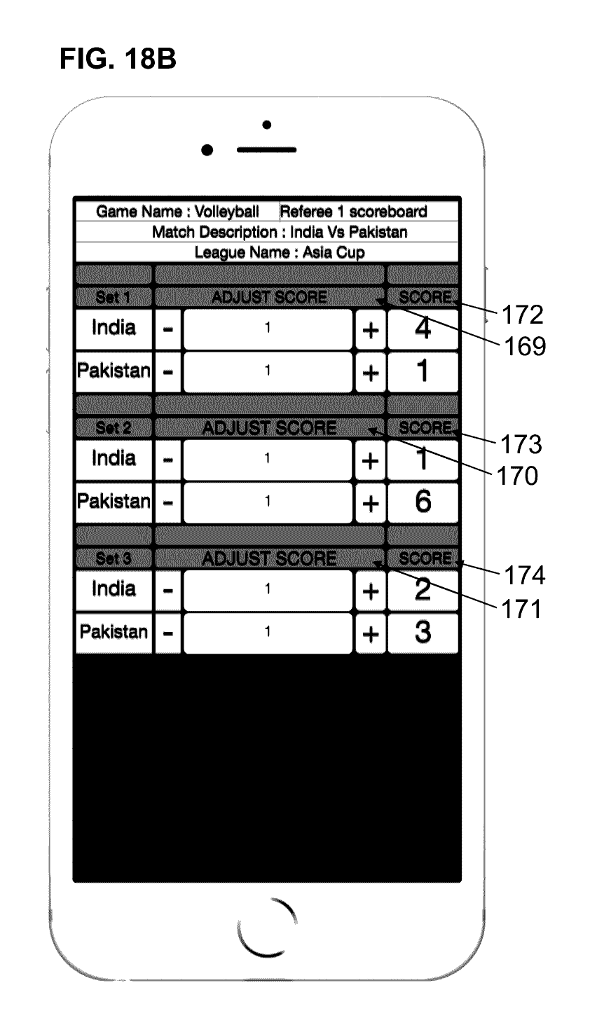

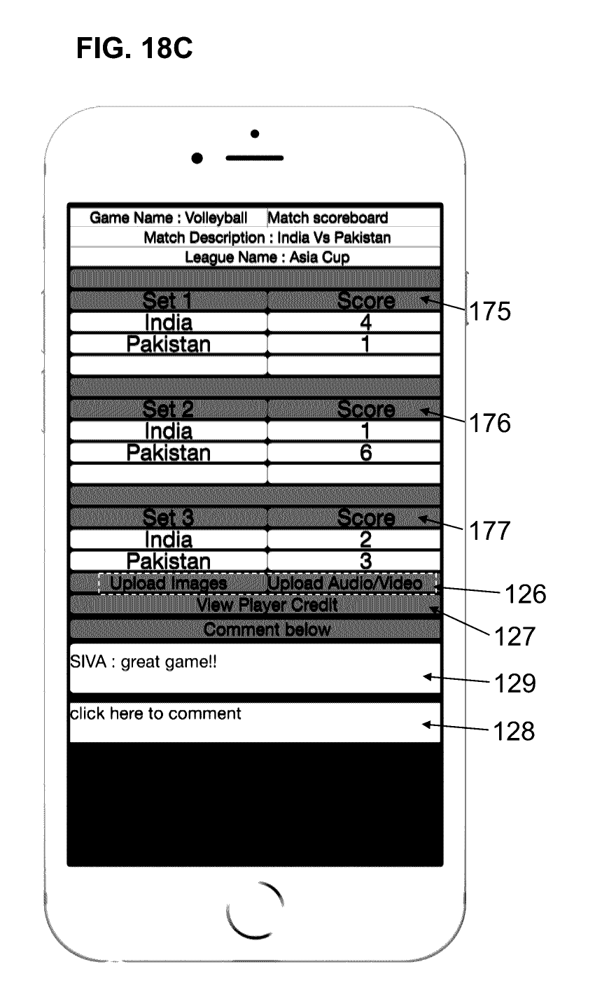

FIGS. 18A-C depict of one embodiment of a Non Time-Based Team Match creation screen, referee scoreboard and match scoreboard, respectively. FIG. 18A shows one embodiment of a list of Match Creation criteria 166, the corresponding information as would be entered by a user creating a Match for a volleyball game 167, and a button that would be selected when the user has entered the Match information and is ready to created the Match 168. FIG. 18B shows one embodiment of the referee scoreboard for the Match created in FIG. 18A having score adjustment options for each team for the first set 169, second set 170 and third set 171, and current scores for each team for the first set 172, second set 173 and third set 174. FIG. 18C shows one embodiment of the Match scoreboard having final scores for each team for the first set 175, second set 176 and third set 177. A user has the option to click on a button to view Player Credits 127. A user also has the option to upload an image or audio or video file 126 or to add a comment 128, which will be posted for all users following the Match to see. Followers of the Match will also be alerted to any upload or comment via a notification on their Home Screen. The user can view all uploads and comments for the Match on this screen 129.

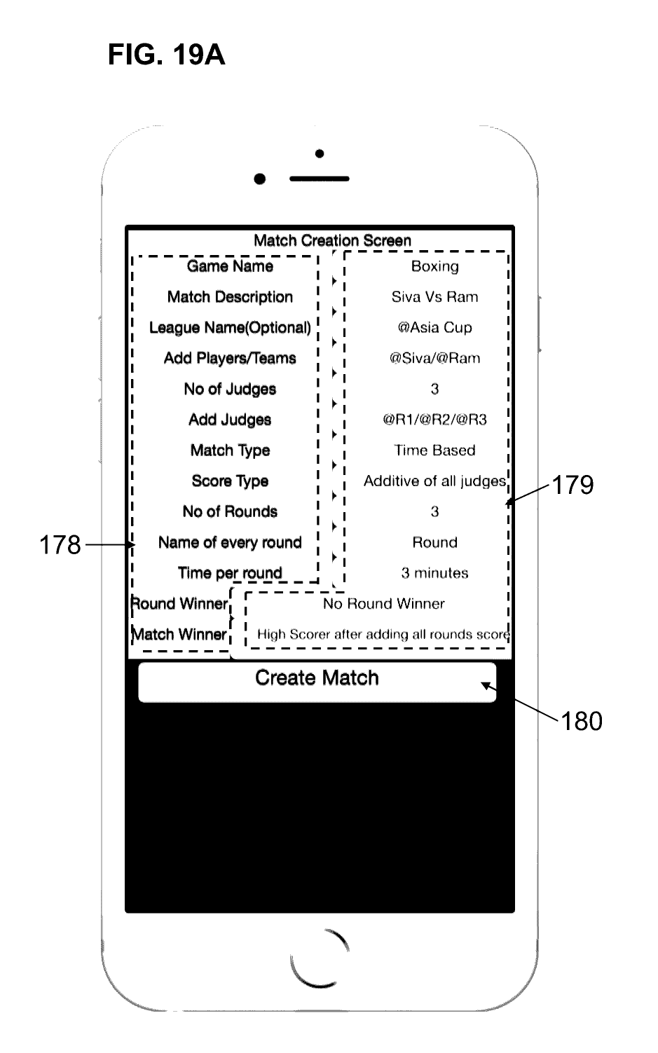

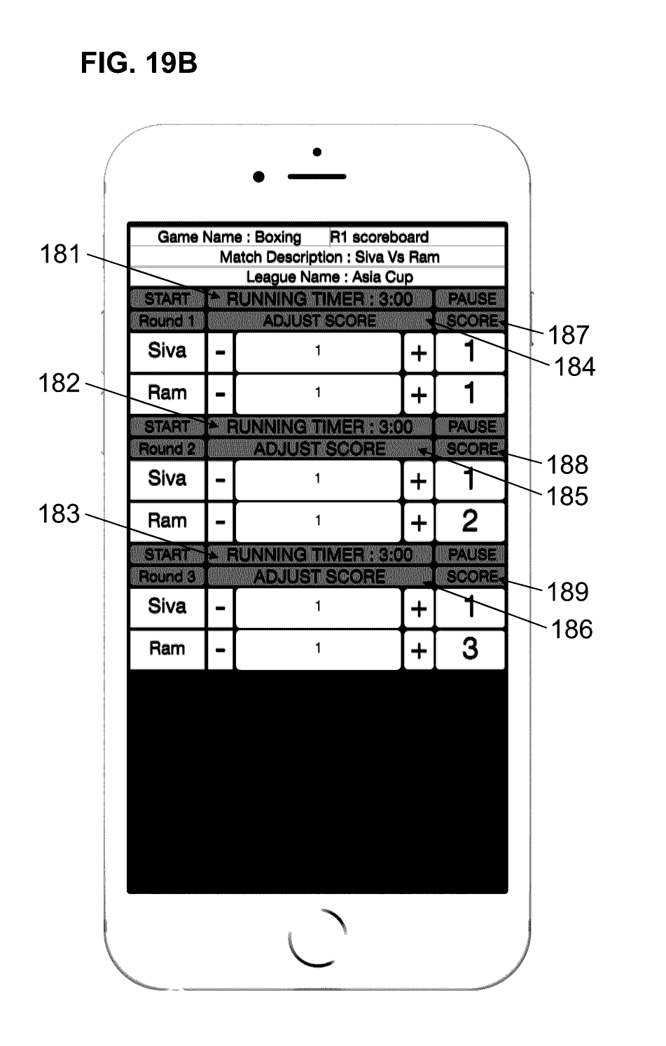

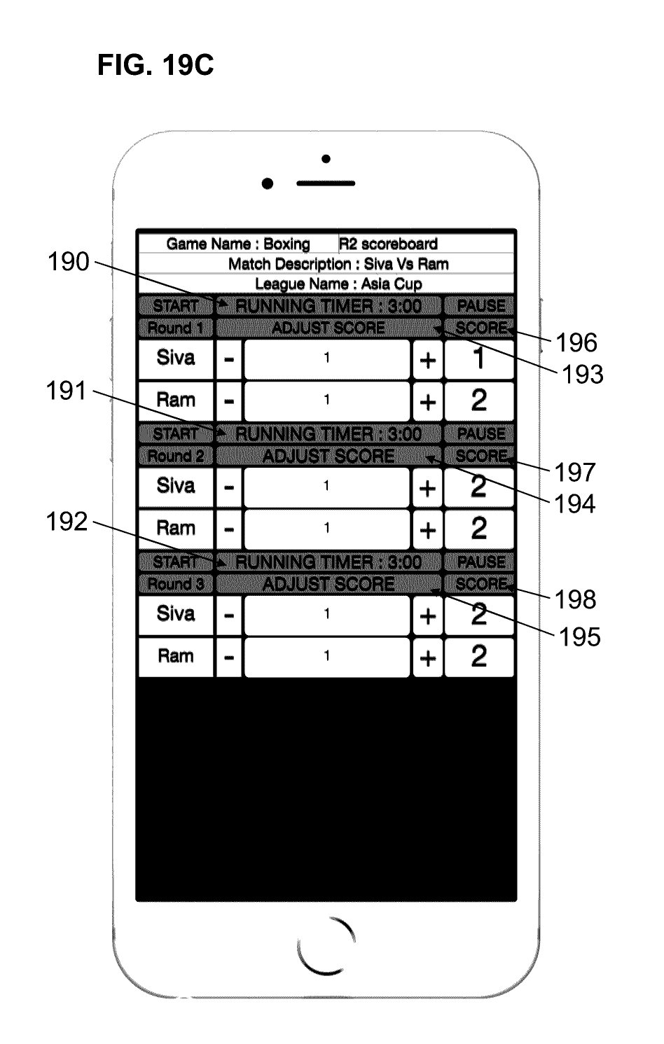

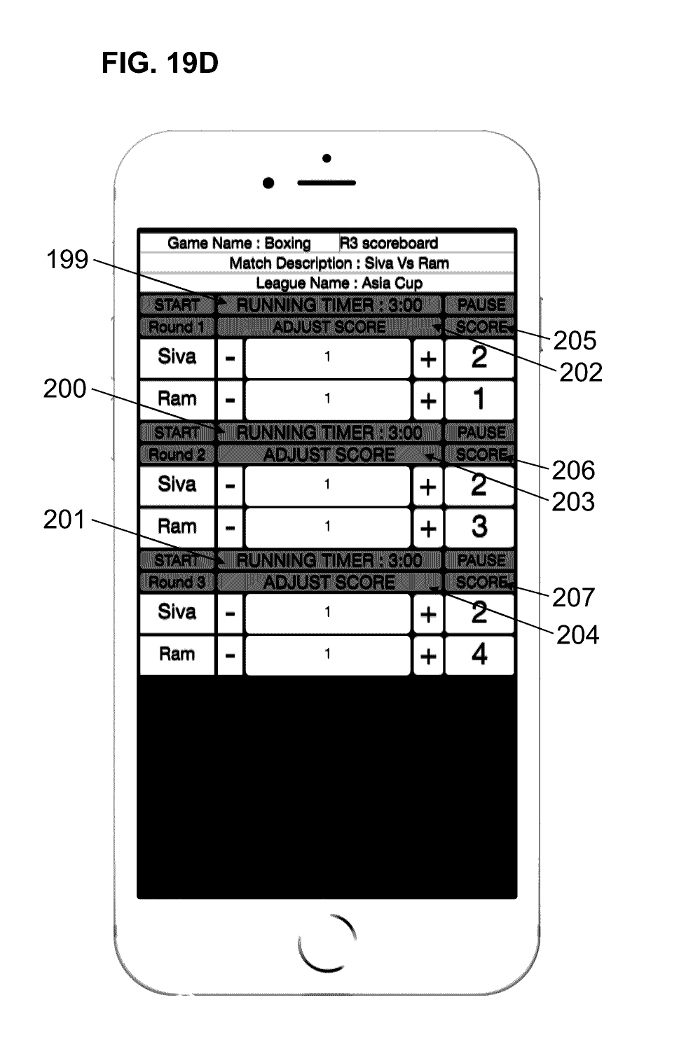

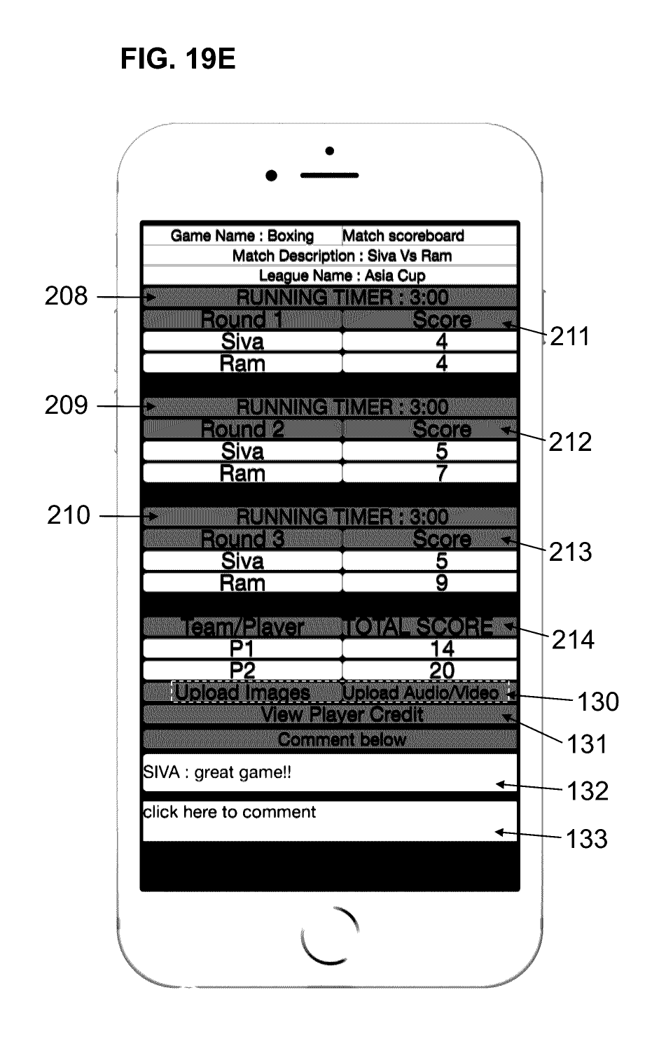

FIGS. 19A-E depict of one embodiment of a Time-Based Individual Match creation screen, referee 1 scoreboard, referee 2 scoreboard, referee 3 scoreboard and match scoreboard, respectively. FIG. 19A shows one embodiment of a list of Match Creation criteria 178, the corresponding information as would be entered by a user creating a Match for a boxing match 179, and a button that would be selected when the user has entered the Match information and is ready to created the Match 180. FIG. 19B shows one embodiment of the referee 1 scoreboard for the Match created in FIG. 19A having running timers for the first round 181, second round 182 and third round 183, score adjustment options for each boxer for the first round 184, second round 185 and third round 186, and current score for each boxer for the first round 187, second round 188 and third round 189. FIG. 19C shows one embodiment of the referee 2 scoreboard for the Match created in FIG. 19A having running timers for the first round 190, second round 191 and third round 192, score adjustment options for each boxer for the first round 193, second round 194 and third round 195, and current score for each boxer for the first round 196, second round 197 and third round 198. FIG. 19D shows one embodiment of the referee 3 scoreboard for the Match created in FIG. 19A having running timers for the first round 199, second round 200 and third round 201, score adjustment options for each boxer for the first round 202, second round 203 and third round 204, and current score for each boxer for the first round 205, second round 206 and third round 207. FIG. 19E shows one embodiment of the Match scoreboard having running timers for the first round 208, second round 209 and third round 210, final score for each boxer for the first round 211, second round 212 and third round 213, and the total score for each boxer 214. A user has the option to click on a button to view Player Credits 131. A user also has the option to upload an image or audio or video file 130 or to add a comment 133, which will be posted for all users following the Match to see. Followers of the Match will also be alerted to any upload or comment via a notification on their Home Screen. The user can view all uploads and comments for the Match on this screen 132.

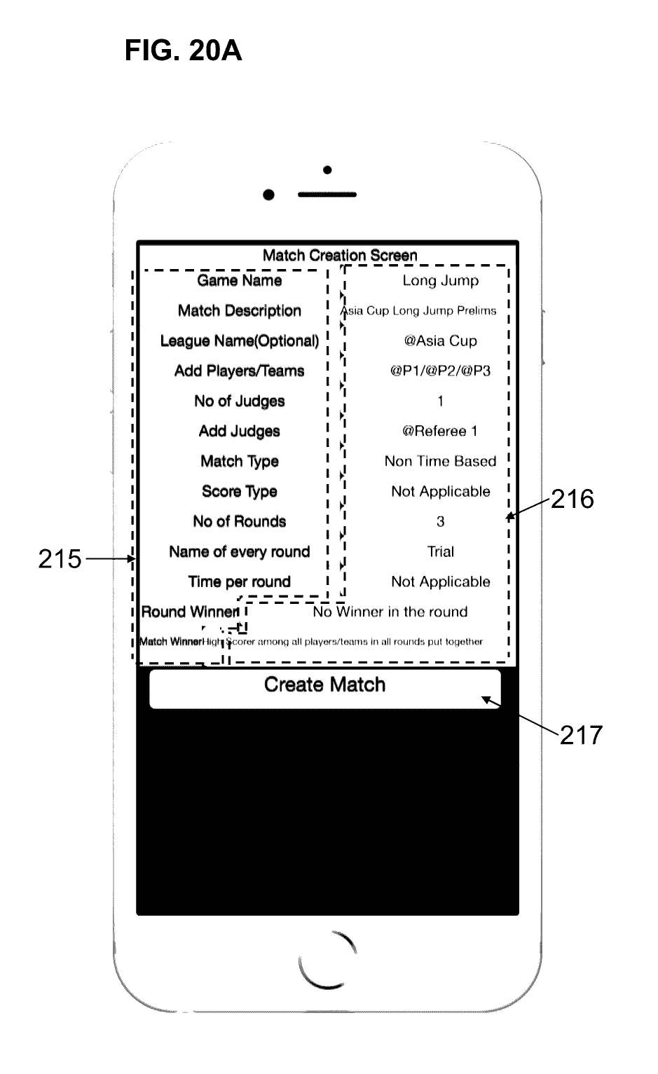

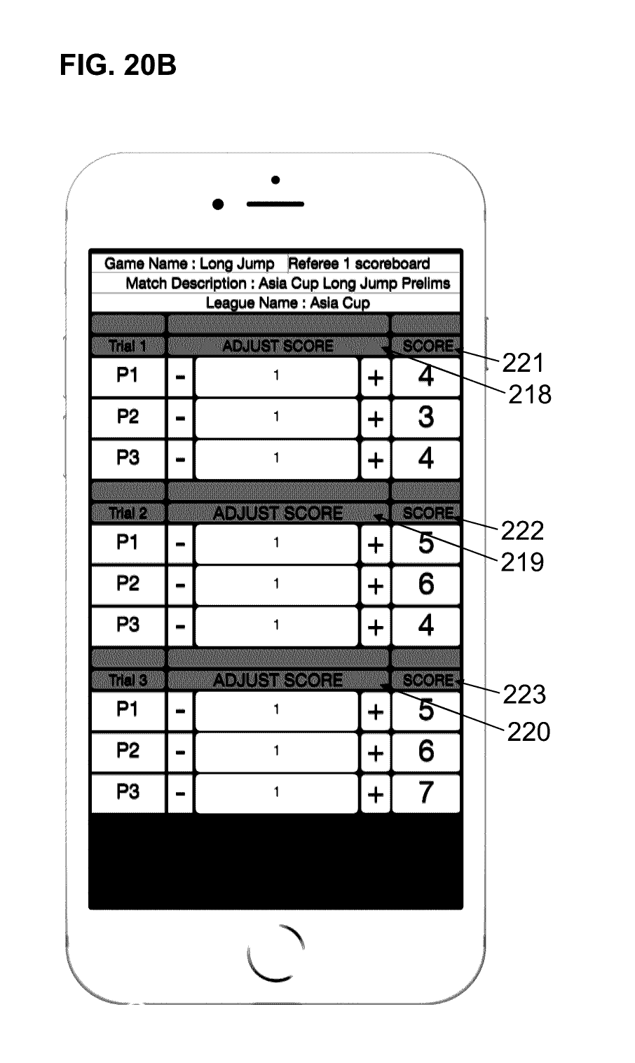

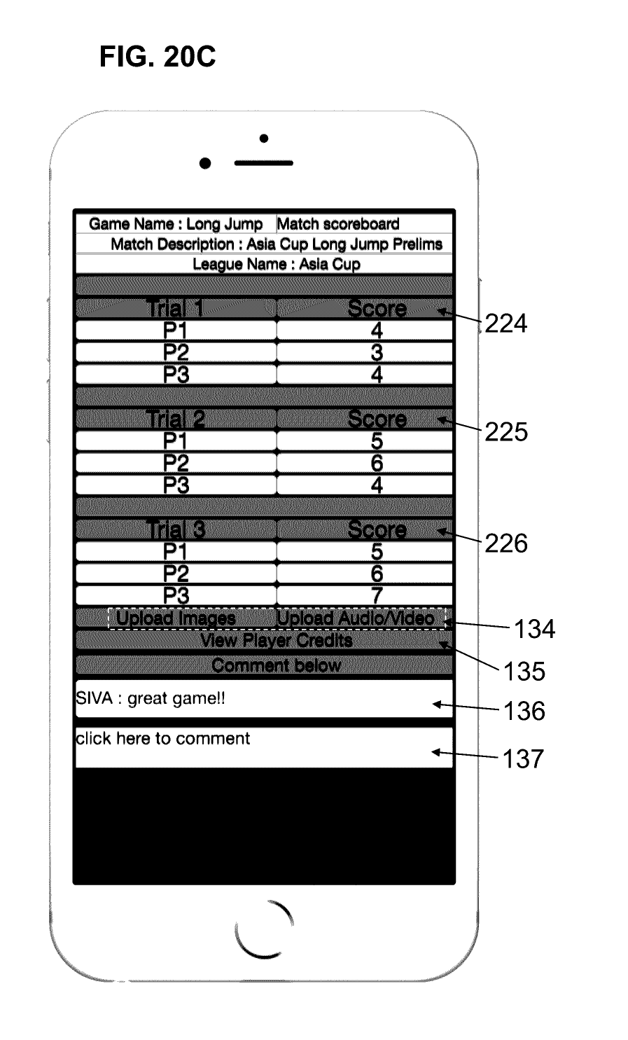

FIGS. 20A-C depict of one embodiment of a Non Time-Based (“Trial”) Individual Match creation screen, referee scoreboard and match scoreboard, respectively. FIG. 20A shows one embodiment of a list of Match Creation criteria 215, the corresponding information as would be entered by a user creating a Match for a long jump competition 216, and a button that would be selected when the user has entered the Match information and is ready to created the Match 217. FIG. 20B shows one embodiment of the referee scoreboard for the Match created in FIG. 20A having score adjustment options for each player for the first trail 218, second trail 219 and third trail 220, and current score for each player for the first trail 221, second trail 222 and third trail 223. FIG. 20C shows one embodiment of the Match scoreboard having a final score for each player for the first trail 224, second trail 225 and third trail 226. A user has the option to click on a button to view Player Credits 135. A user also has the option to upload an image or audio or video file 134 or to add a comment 136, which will be posted for all users following the Match to see. Followers of the Match will also be alerted to any upload or comment via a notification on their Home Screen. The user can view all uploads and comments for the Match on this screen 137.

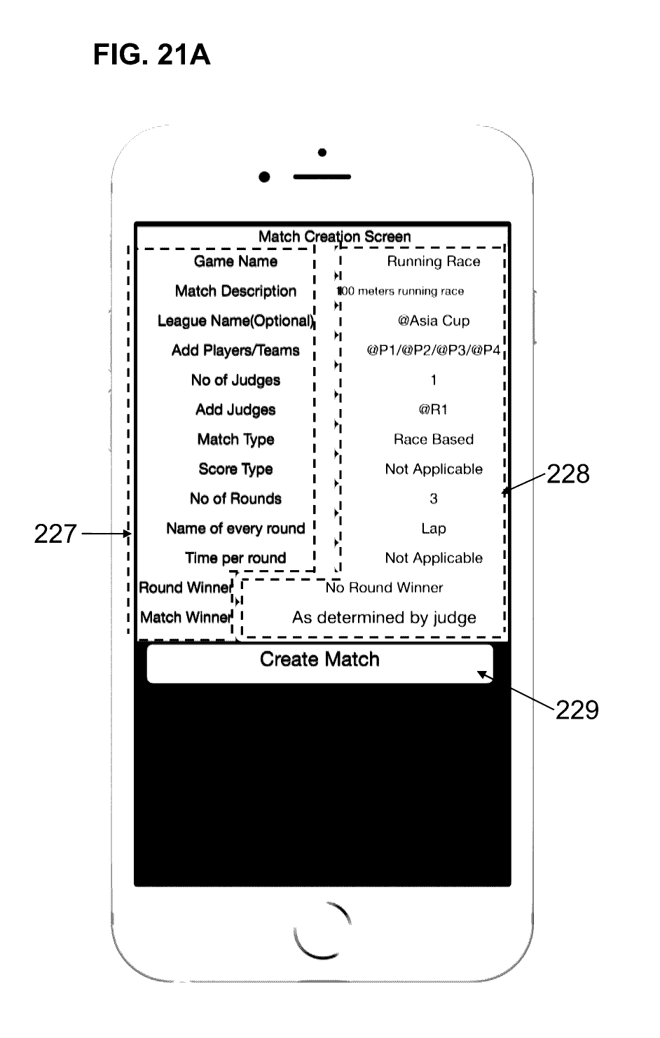

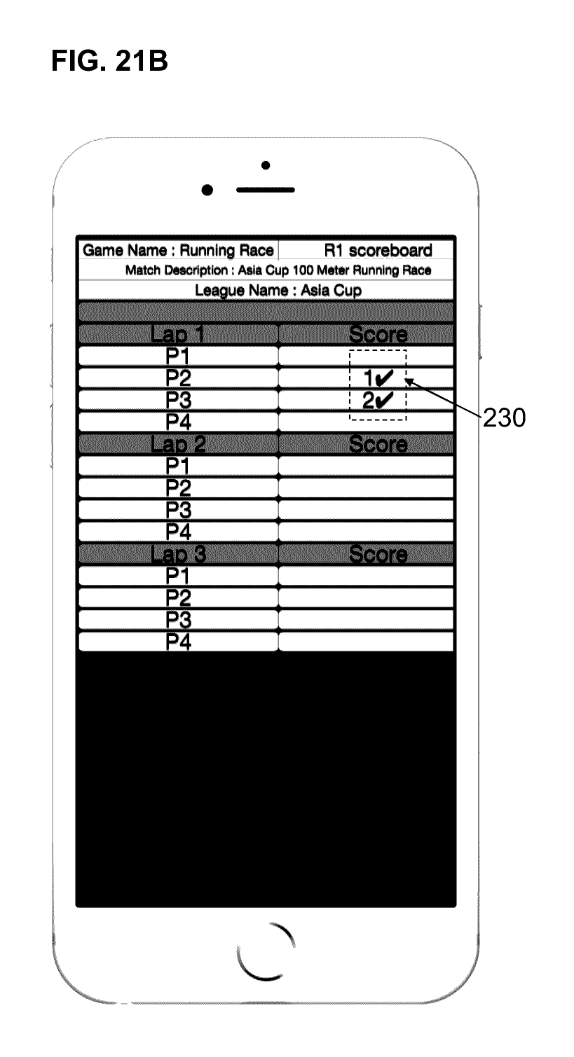

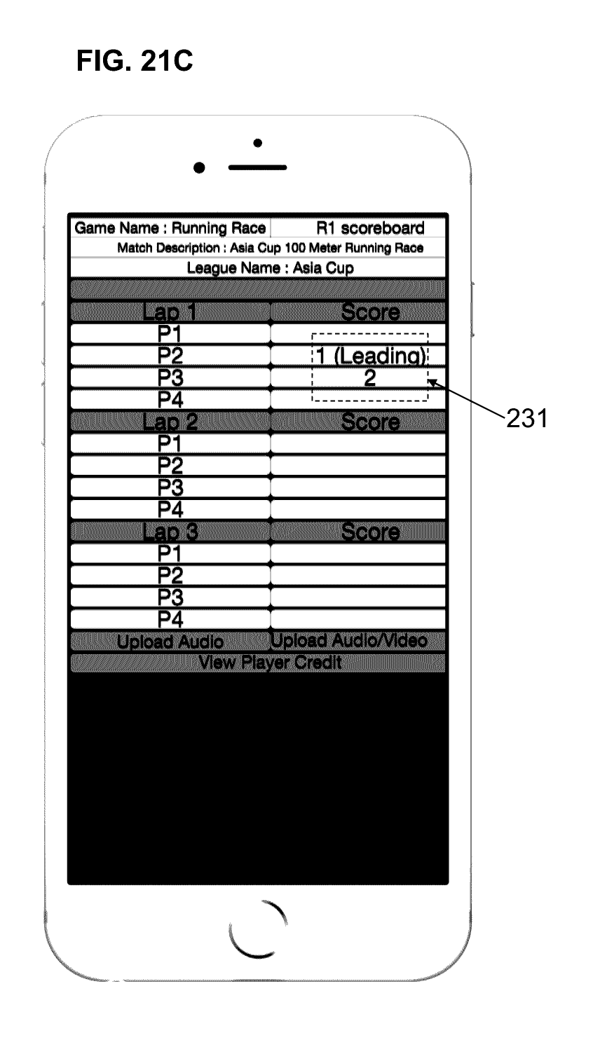

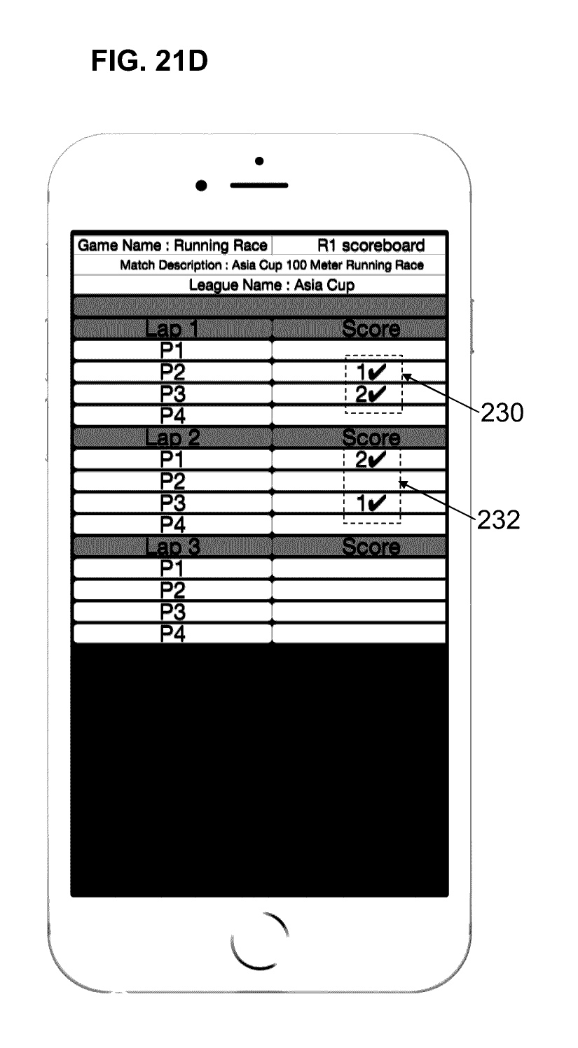

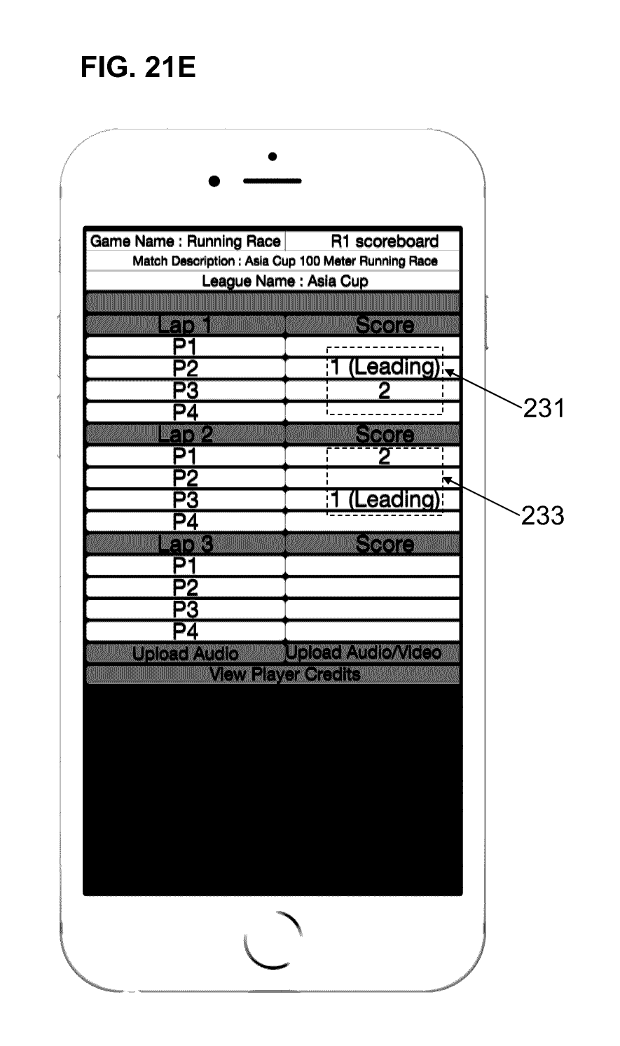

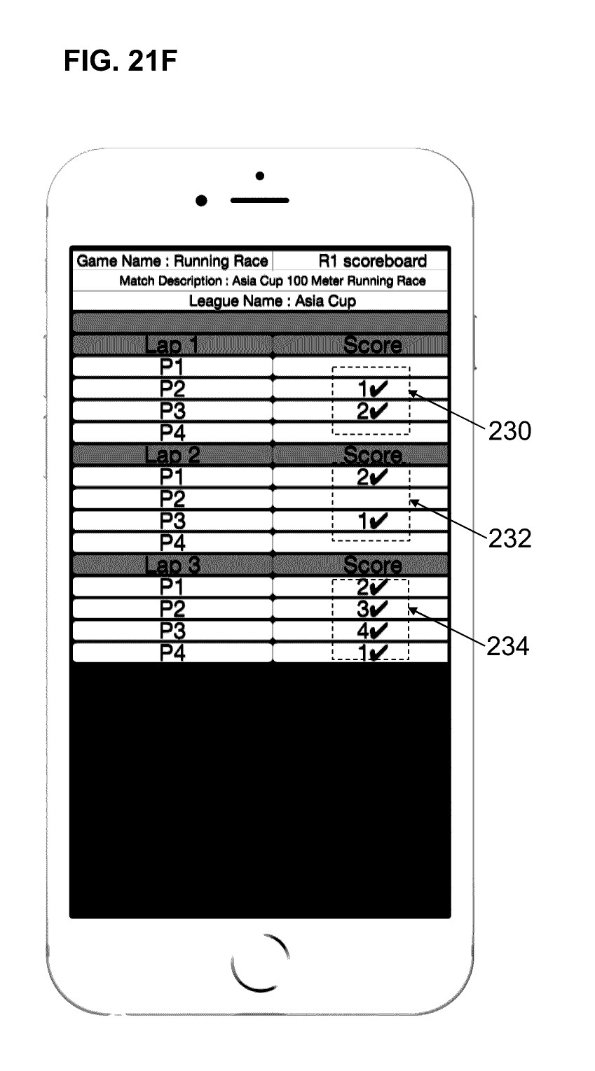

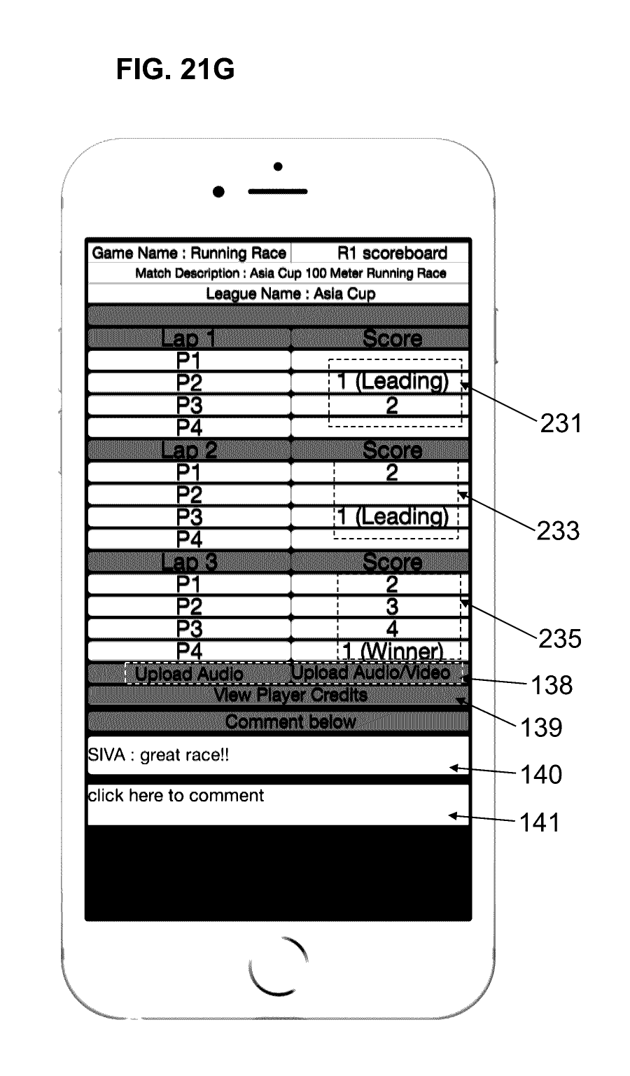

FIGS. 21A-G depict of one embodiment of a Race-Based Individual Match creation screen, referee scoreboard after lap 1 (in this embodiment, a lap is a round), match scoreboard after lap 1, referee scoreboard after lap 2, match scoreboard after lap 2, referee scoreboard after lap 3, and match scoreboard after lap 3, respectively. FIG. 21A shows one embodiment of a list of Match Creation criteria 227, the corresponding information as would be entered by a user creating a Match for a running race 228, and a button that would be selected when the user has entered the Match information and is ready to created the Match 229. FIG. 21B shows one embodiment of the referee scoreboard after lap 1 for the race created in FIG. 21A having the referee's selections for the racers in the first and second positions 230. FIG. 21C shows one embodiment of the match scoreboard after lap 1 showing the players in the first two positions and noting which player is leading after the most recent lap 231. FIG. 21D shows one embodiment of the referee scoreboard after lap 2 for the race created in FIG. 21A having the referee's selections for the racers in the first and second positions for the first lap 230 and second lap 232. FIG. 21E shows one embodiment of the match scoreboard after lap 2 showing the players in the first two positions and noting which is player is leading after each of the first lap 231 and second lap 233. FIG. 21F shows one embodiment of the referee scoreboard after lap 3 for the race created in FIG. 21A having the referee's selections for the racers in the first and second positions for the first lap 230, the second lap 232 and the third lap 234. FIG. 21G shows one embodiment of the match scoreboard after lap 3 showing the players in the first two positions and noting which player is leading after the first lap 231 and second lap 233, and the players in the first two positions and noting which is the winner after the final lap 235. A user has the option to click on a button to view Player Credits 139. A user also has the option to upload an image or audio or video file 138 or to add a comment 141, which will be posted for all users following the Match to see. Follows of the Match will also be alerted to any upload or comment via a notification on their Home Screen. The user can view all uploads and comments for the Match on this screen 140.

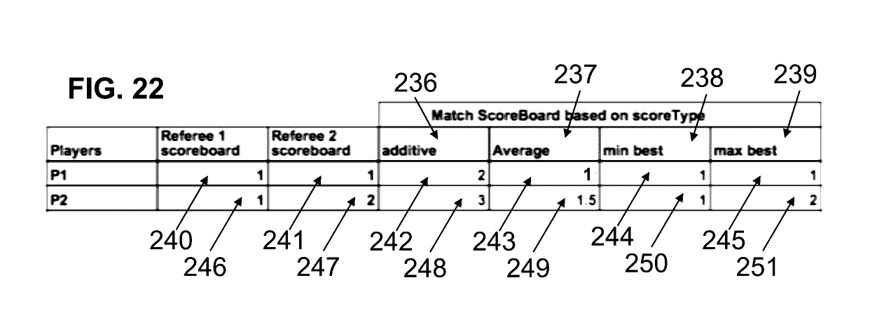

FIG. 22 is a table showing the scores that would appear on the app scoreboard for a match having two players and two referees for each of the four score types: additive 236, average 237, minimum best 238 and maximum best 239. As an example, Player 1 receiving a score of 1 from referee 1 240 and a score of 1 from referee 2 241 would have an additive score of 2 242, an average score of 1 243, a minimum best score of 1 244 and maximum best score of 1 245. Player 2 receiving a score of 1 from referee 1 246 and a score of 2 from referee 2 247 would have an additive score of 3 248, an average score of 1.5 249, a minimum best score of 1 250 and maximum best score of 2 251.

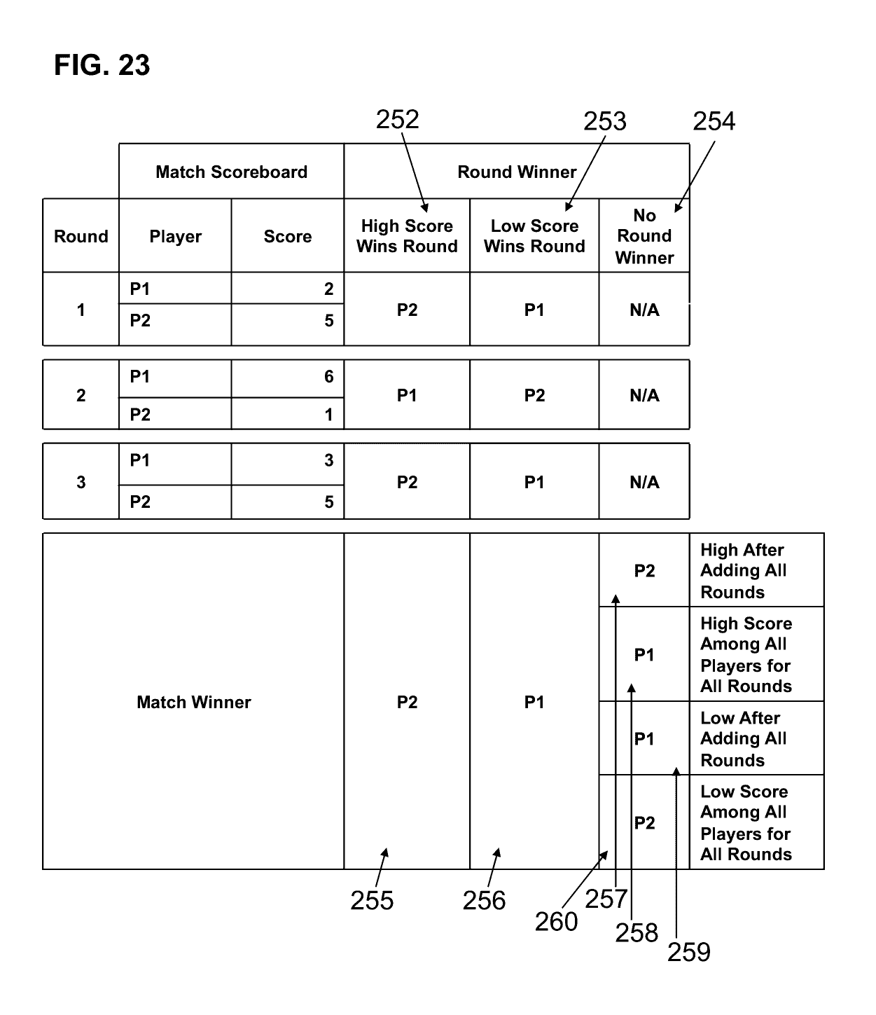

FIG. 23 is a table showing the round winner and match winner for a match having two players and three rounds. For each round, the table shows the score of each player, the winner of the round where the winner is set to be the player with the highest score 252 and the winner of the round where the winner is set to be the player with the lowest score 253. Where Player 2 has the highest score in two rounds and Player 1 has the highest score in one round where the player having the highest score is a round winner, Player 2 is the match winner 255. Where Player 1 has the lowest score in two rounds and Player 2 has the lowest score in one round where the player having the lowest score is a round winner, Player 1 is the match winner 256. In a match where there is “no round winner” 254: Player 2 in the instant table would be the high score winner after adding all round scores 257; Player 1 would be the high score winner among all players in all rounds combined 258; Player 1 would be the low score winner after adding all round scores 259; and Player 2 would be the low score winner among all players in all rounds combined 260.

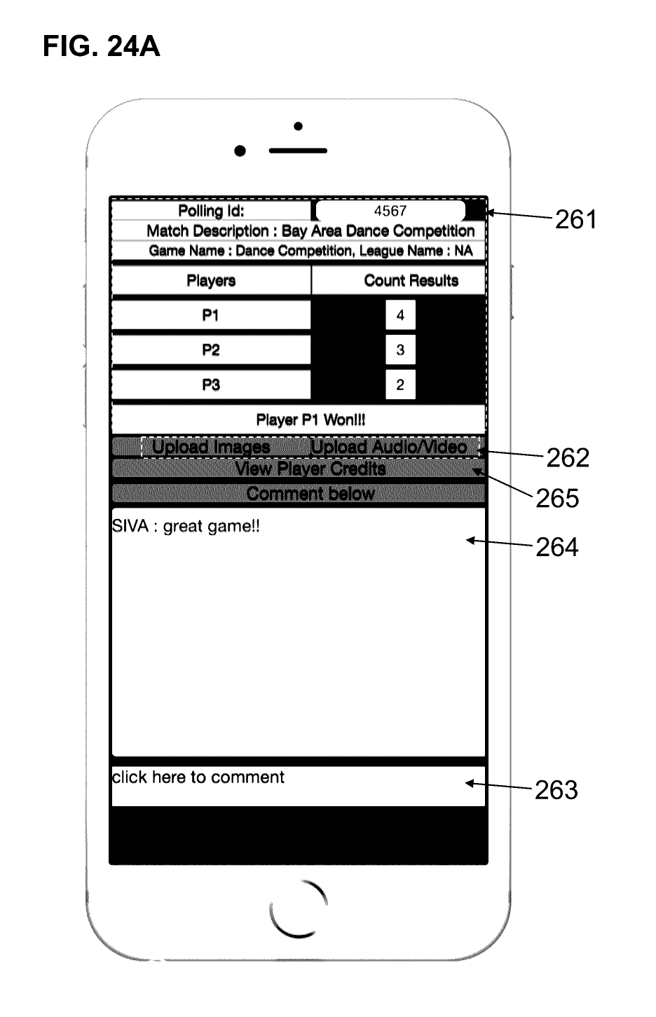

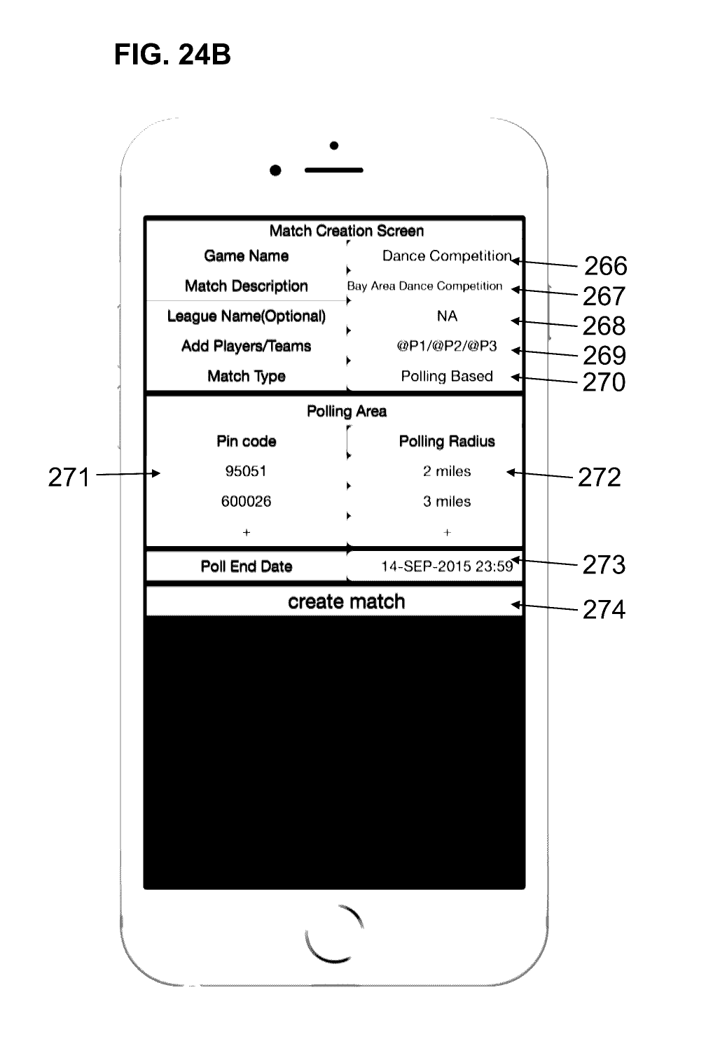

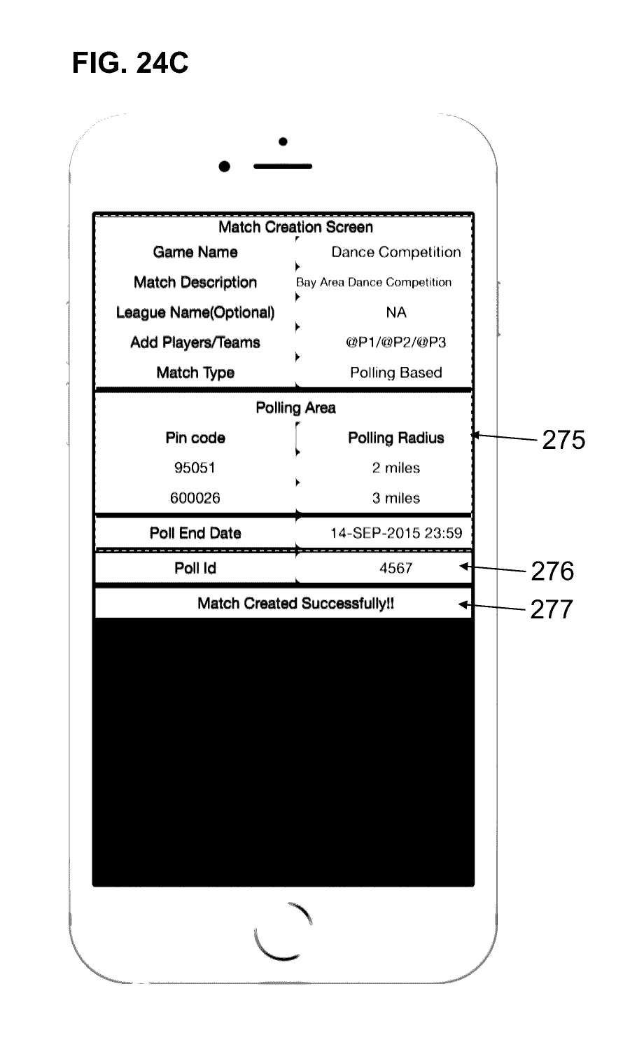

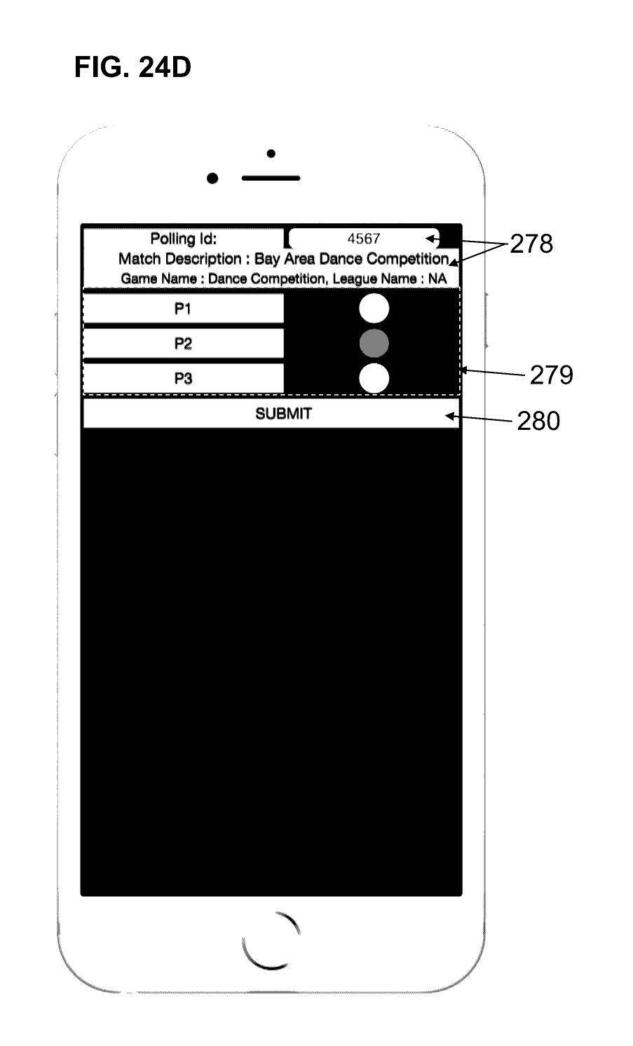

FIGS. 24A-D depict one embodiment of the read-only screen for a user poll, poll creation screen, poll creation confirmation screen, and poll entry screen, respectively. FIG. 24A depicts one embodiment of the read-only screen for a user poll where a user can view poll details 261, upload an image, audio or video file 262, add a comment 263, view files and comments that followers of the poll have added 264, and view Player credits that have been awarded the poll Administrator 265. FIG. 24B depicts one embodiment of the poll creation screen where a user creating a poll can specify the poll name 266, match (poll) description 267, league name (if applicable) 268, Player IDs to be added to the poll 269, and that the Match is a poll 270. The user can also specify one or more map pin codes 271 corresponding to one or more map locations and the distance 272 from each pin within which users are allowed to vote. The user can also set a poll end date 273 and then click “create match” 274 when ready to create the poll. FIG. 24C depicts one embodiment of the poll creation confirmation screen that a user sees after clicking “create match” as shown in FIG. 24C. When a poll is successfully created, a user will view the poll information 275, see the poll ID 276 assigned to the match, and see the words “Match Successfully Created” 277. FIG. 24D depicts one embodiment of the poll entry screen where a user can view the poll information 278, select the radio button next to the Player for whom the user wants to cast their vote 279, and click “SUBMIT” 280 to enter their vote.

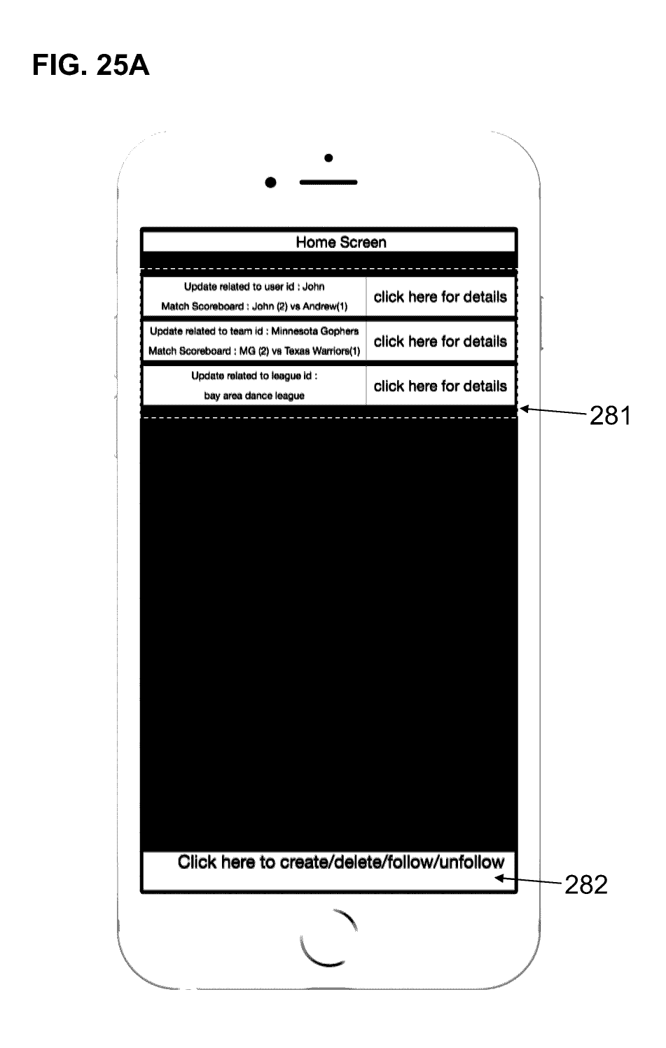

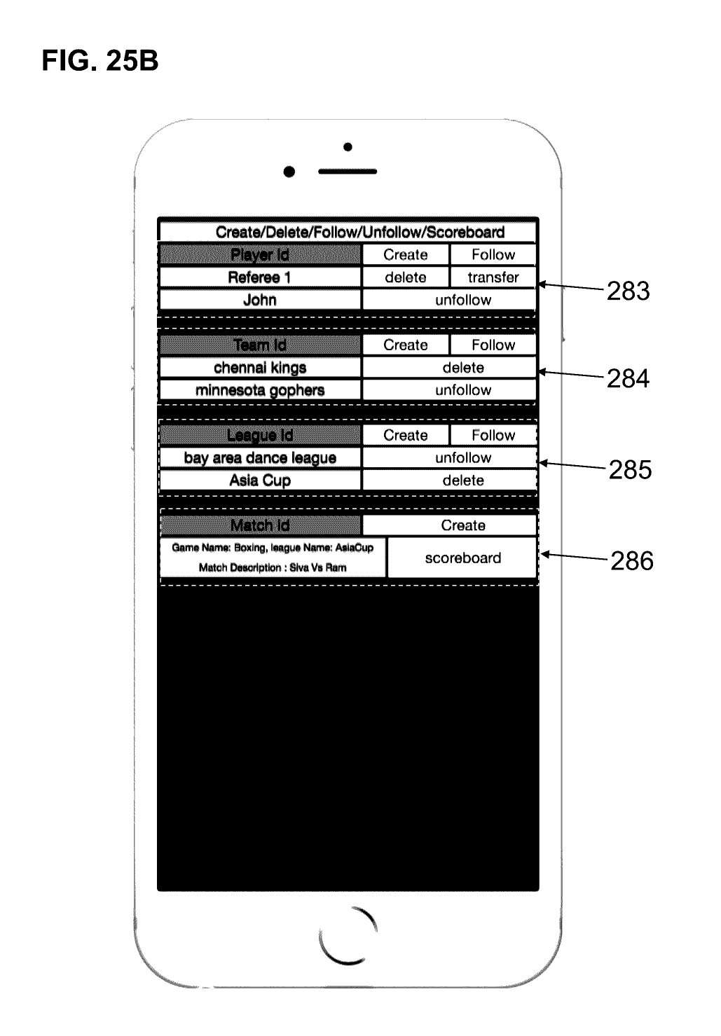

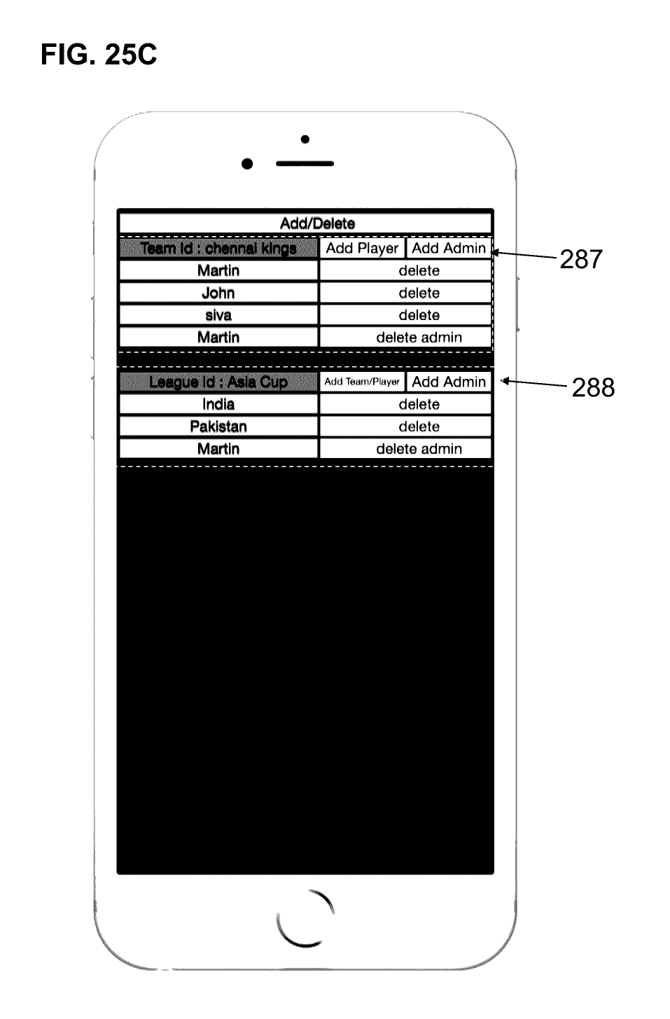

FIGS. 25A-C depict one embodiment of a user's Home Screen, Player/Team/League/Match ID management screen, and Team and League player management screen, respectively. FIG. 25A depicts one embodiment of a user's Home Screen where a user can view, by default, notifications of activity by Players, Teams, Leagues or Matches the user is following 281. At the bottom of the screen, the user can select to view the Player/Team/League/Match ID management screen 282. FIG. 25B depicts one embodiment of a user's Player/Team/League/Match ID management screen where a user can create, delete, transfer or follow a Player ID 283, create, delete or follow a Team ID 284, create, delete or follow a League ID 285, create or delete a Match 286. FIG. 25C depicts one embodiment of the Team and League player management screen where a user can add and delete players and administrators to/from a Team 287 add and delete players and teams, as well as administrators, to/from a League 288.

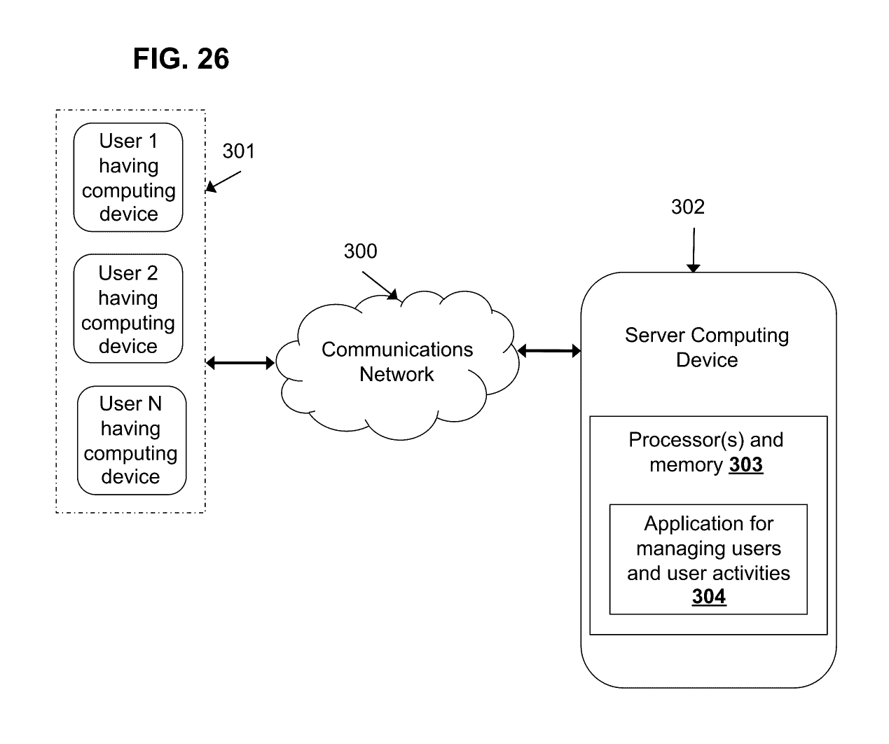

FIG. 26 is a simplified schematic diagram of a system for customizable scoreboarding. In one implementation, the new application is served content from a service provider storefront sever, such as the Android or Apple app store. The new application will then be received and installed on the user's computing device 301. The application is then connected to the communications network 300 employed by the user's computing device. Also connected to the communications network is a server computing device 302. Server computing device 302 may be a network computer, host computer, network server, web server, email server or any computing device for hosting email communications applications and systems. Although end user computing devices 301 are described as a personal computing device, these may be any type of computing device such as a cell phone, laptop, mobile or portable computing device, smart phone, desktop computer, personal computer, PDA (personal device assistant), music player, television, set top box, or game player device. In one implementation, server computing device 302 includes one or more processors and computer memory 303 containing an application 304 for managing users and user activities commanded by users on the user computing devices 301.

As to further discussion of the manner of usage and operation of the present invention, the same should be apparent from the above description. With respect to the above description then, it is to be realized that the optimum dimensional relationships for the parts of this invention, to include variations in design, form, function and manner of coding and operation, assembly and use, are deemed readily apparent and obvious to one skilled in the art, and all equivalent relationships to those illustrated in the drawings and described in the specification are intended to be encompassed by the present invention.

Although the description presented heretofore contains specificities for the benefit of illustration, these should not be construed as limiting the scope of the embodiments but rather as illustrative examples of some of the several embodiments. Thus, the scope of the embodiments should be determined by the appended claims and their legal equivalents rather than by the examples provided.

What is claimed is:

1. A method for providing and managing scoreboarding of real-time, real-life games using a server connected to a plurality of user computing devices via a communications network, the method comprising;
a communications network capable of sending and receiving electronic information;
a plurality of users each having a mobile user computing device connected to said communications network;
at least one said user who is a match administrator;
at least one said user who is a match scorer designated by the at least one match administrator;
at least one player designated by the at least one match administrator;
a server comprising a processor and memory, the server being connected to the plurality of user devices via said communications network, said server being capable of:
receiving, from the user computing device of a match administrator, via the communications network, a selection of a match type, selection of match type parameter values, and selection of at least one player and at least one match scorer to be added to the match;
receiving, from a user device of the at least one match scorer, via the communications network, a scoring claim as documented by the at least one match scorer;
receiving, from a user device of at least one of the plurality of users, via the communications network, player ID management selections, team ID management selections, league ID management selections, follow notification management and view screen selections;
receiving, from a user device of at least one of the plurality of users, via the communications network, media associated with a user-selected match;
receiving information related to a user associated with a user computing device via the communications network, the information including user location information; and
said user computing device being capable of receiving updated information and notification associated with a match, player ID, team ID, or league ID that a user is following.

2. The method of claim 1, wherein the match type is selected from a set of established match types, and the match type parameters are a set of established match type parameters specific to and associated with each said established match type.

3. The method of claim 1, wherein the match type can be set to any one of at least four possible match types, including time-based, non time-based, race and poll.

4. The method of claim 1, wherein a player can be an individual user or a team of more than one user.

5. The method of claim 1, wherein the scoring method is determined by the selected match type and selected match type parameter values.

6. The method of claim 1, wherein the score of each player in a match is based on inputs received from the at least one match scorer.

7. The method of claim 1, wherein the at least one match scorer can include the match administrator or not include the match administrator at the match administrator's discretion.

8. The method of claim 1, wherein the scoring claim is based on the match type and can include individual or team player points, individual player credits, and individual or team player ranking.

9. The method of claim 1, wherein the player ID management selections include options for a user to create a player ID, delete a player ID, and transfer a player ID to another user.

10. The method of claim 1, wherein the team ID management selections include options for a user to create a team ID and the corresponding team ID parameters, delete a team ID, add one or more individual players to a team ID, and delete one or more individual players from a team ID.

11. The method of claim 1, wherein the league ID management selections include options for a user to create a league ID and the corresponding league ID parameters, delete a league ID, add one or more individual or team players to a league ID, and delete one or more individual or team players from a league ID.

12. The method of claim 1, wherein the follow notification management comprises enabling a user to selected and deselect a match, player ID, team ID, or league ID the user wishes to follow and for which the user wishes to receive notification when an event occurs in association with the follow notification selection.

13. The method of claim 1, wherein the view screen selections are based on established view screen options presented to the user for the user to view statistics and user-provided content associated with a match, player ID, team ID, or league ID the user is following.

14. The method of claim 1, wherein the media is of a type including audio, video, photograph and text.

15. The method of claim 1, wherein the match administrator is, by default, the user who creates the match, and the match administrator can select one or more other users to be match administrators for any match administered by said match administrator.
